(19) United States
(12) Patent Application Publication
(10) Pub. No.: US 2012/0249463 A1
(43) Pub. Date: Oct. 4, 2012

(54) INTERACTIVE INPUT SYSTEM AND METHOD

(75) Inventors: Andrew Leung, Calgary (CA); Edward Tse, Calgary (CA); Min Xin, Calgary (CA)

(73) Assignee: SMART TECHNOLOGIES ULC, Calgary (CA)

(21) Appl. No.: 13/436,798

(22) Filed: Mar. 30, 2012

Related U.S. Application Data
(63) Continuation-in-part of application No. 12/794,655, filed on Jun. 4, 2010.

(51) Int. Cl. G06F 3/041

(52) U.S. Cl. 345/173

(57) ABSTRACT

An interactive input system comprises an interactive surface; and processing structure for receiving an image from a mobile computing device, and processing the received image for display on the interactive surface.

### CROSS-REFERENCE TO RELATED APPLICATIONS

This application is a continuation-in-part of U.S. patent application Ser. No. 12/794,655 to Tse, et al., filed on Jun. 4, 2010, and entitled “Interactive Input System and Method”, the entire content of which is incorporated herein by reference.

### FIELD OF THE INVENTION

The present invention relates generally to interactive input systems methods of using the same.

### BACKGROUND OF THE INVENTION

Interactive input systems that allow users to inject input (e.g., digital ink, mouse events, etc.) into an application program using an active pointer (e.g., a pointer that emits light, sound or other signal), a passive pointer (e.g., a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the entire contents of which are incorporated by reference; touch systems comprising touch panels employing electromagnetic, capacitive, acoustic or other technologies to register pointer input; tablet and laptop personal computers (PCs); personal digital assistants (PDAs) and other handheld devices; and other similar devices.

Above-incorporated U.S. Pat. No. 6,803,906 to Morrison, et al., discloses a touch system that employs machine vision to detect pointer interaction with a touch surface on which a computer-generated image is presented. A rectangular bezel or frame surrounds the touch surface and supports imaging devices in the form of digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a finger, pointer, pen tool, etc., touches the optical waveguide surface, due to a change in the index of refraction of the optical waveguide, causing some light to escape from the touch point. In such multi-touch interactive input systems, the machine vision system captures images including the point(s) of escaped light, and processes the images to identify the position of the pointers on the optical waveguide surface based on the point(s) of escaped light for use as input to application programs.

U.S. Patent Application Publication No. 2011/0050650 to McGibney, et al., assigned to SMART Technologies ULC, discloses an interactive input system with improved signal-to noise ratio and image capture method. The interactive input system comprises an optical waveguide associated with a display having a top surface with a diffuser for displaying images projected by a projector and also for contact by an object, such as a finger, pointer or the like. The interactive input system also includes two light sources. Light from a first light source is coupled into the optical waveguide and undergoes total internal reflection within the optical waveguide. Light from a second light source is directed towards a back surface of the optical waveguide opposite to its top surface. At least one imaging device, such as a camera, has a field of view looking at the back surface of the optical waveguide and captures image frames in a sequence with the first light source and the second light source on and off alternately. Pointer interactions with the top surface of the optical waveguide can be recorded as handwriting or drawing to control execution of the application program.

Other arrangements have also been considered. For example, U.S. Patent Application Publication No. 2010/010330 to Morrison, et al., assigned to SMART Technologies ULC, discloses an image projecting method comprising determining the position of a projection surface within a projection zone of at least one projector based on at least one image of the projection surface, the projection zone being sized to encompass multiple surface positions and modifying video image data output to the at least one projector so that the projected image corresponds generally to the projection surface. In one embodiment, a camera mounted on a projector is used to determine the location of a user in front of the projection surface. The position of the projection surface is then adjusted according to the height of the user.

U.S. Patent Application Publication No. 2007/0273842 to Morrison, et al., assigned to SMART Technologies ULC, discloses a method of inhibiting a subject's eyes from being exposed to projected light when the subject is positioned in front of a background on which an image is displayed comprising capturing at least one image of the background including the displayed image, processing the captured image to detect the existence of the subject and to locate generally the subject and masking image data used by the projector to project the image corresponding to a region that encompasses at least the subject's eyes.

While the above-described prior art systems and methods provide various approaches for receiving user input, limited functionality is available for adapting display content to a user's position relative to an interactive surface. It is therefore an object to provide a novel interactive input system and method.

### SUMMARY OF THE INVENTION

Accordingly, in one aspect there is provided an interactive input system comprising an interactive surface, and processing structure for receiving an image from a mobile computing device, and processing the received image for display on the interactive surface.

According to another aspect there is provided a method comprising receiving an image from a mobile computing device, and processing the received image for display on an interactive surface.

According to still yet another aspect there is provided a non-transitory computer readable medium embodying a computer program for execution by a computer, the computer program comprising program code for receiving an image from a mobile computing device, and program code for processing the received image for display on an interactive surface.

### BRIEF DESCRIPTION OF THE DRAWINGS

Embodiments will now be described more fully with reference to the accompanying drawings in which:

FIG. 1 is a perspective view of an interactive input system.

FIG. 2 is a top plan view of the interactive input system of FIG. 1 installed in an operating environment.

FIG. 3A is a graphical plot of output of a proximity sensor forming part of the interactive input system of FIG. 1 as a function of time.

FIG. 3B is a graphical plot showing output of a set of proximity sensors forming part of the interactive input system of FIG. 1 at one point in time and as a function of proximity sensor position.

FIGS. 4A to 4D are graphical plots showing output from each of the proximity sensors in the set of FIG. 3B as a function of time.

FIG. 5 is a schematic diagram showing operating modes of the interactive input system of FIG. 1.

FIG. 6 is a flowchart showing steps in an operation method used by the interactive input system of FIG. 1.

FIG. 7 is a flowchart showing steps in a user interface component updating step of the method of FIG. 6.

FIGS. 8A to 8D are examples of display content configurations for the interactive input system of FIG. 1.

FIGS. 9A to 9C are examples of hand gestures recognizable by the interactive input system of FIG. 1.

FIGS. 10A and 10B are further examples of display content configurations for the interactive input system of FIG. 1.

FIG. 11 is a top plan view of another embodiment of an interactive input system installed in an operating environment.

FIG. 12 is a top plan view of yet another embodiment of an interactive input system installed in an operating environment.

FIGS. 13A to 13C are front elevational views of interactive boards forming part of yet another embodiment of an interactive input system.

FIG. 13D is a front elevational view of interactive boards forming part of yet another embodiment of an interactive input system.

FIG. 14 is a perspective view of still yet another embodiment of an interactive input system.

FIG. 15 is a top plan view of a display content configuration for the interactive input system of FIG. 14.

FIGS. 16A to 16D are top plan views of further display content configurations for the interactive input system of FIG. 14.

FIGS. 17A and 17B are top plan views of still further display content configurations for the interactive input system of FIG. 14.

FIG. 18 is a perspective view of still yet another embodiment of an interactive input system.

FIG. 19 shows an exemplary display image presented on an interactive surface and on a mobile computing device.

FIG. 20 is a flowchart showing a method for sending a display image to an I/O interface of the mobile computing device of FIG. 19.

FIGS. 21A to 21C show examples of a display image sent from the mobile computing device to the interactive surface.

FIG. 22 shows another example of a display image sent from the mobile computing device to the interactive surface.

FIG. 23 is a perspective view of still yet another embodiment of an interactive input system.

FIGS. 24A to 24E show examples of a display image sent from a mobile computing device to an interactive surface forming part of the interactive input system of FIG. 23.

FIGS. 25A and 25B are cross-sectional views of a docking mechanism.

### DETAILED DESCRIPTION OF THE EMBODIMENTS

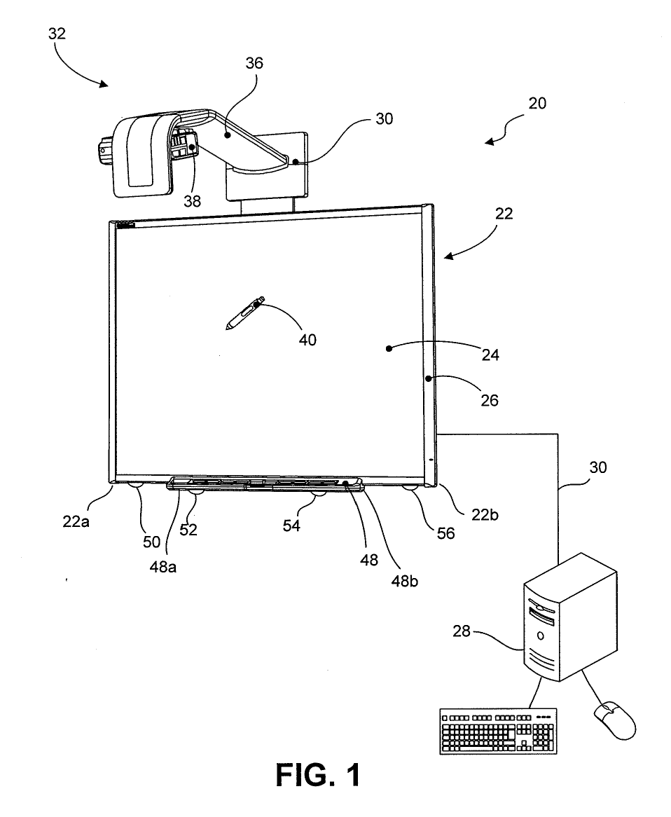

Turning now to FIG. 1, an interactive input system that allows a user to inject input such as digital ink, mouse events, etc., into an application program is shown and is generally identified by reference numeral 20. In this embodiment, interactive input system 20 comprises an interactive board 22 mounted on a vertical support surface such as for example, a wall surface or the like. Interactive board 22 comprises a generally planar, rectangular interactive surface 24 that is surrounded about its periphery by a bezel 26. A boom assembly 32 is also mounted on the support surface above the interactive board 22. Boom assembly 32 provides support for a short throw projector 38 such as that sold by SMART Technologies ULC under the name “SMART Unifi 45”, which projects an image, such as for example a computer desktop, onto the interactive surface 24.

The interactive board 22 employs machine vision to detect one or more pointers brought into a region of interest in proximity with the interactive surface 24. The interactive board 22 communicates with a computing device 28 executing one or more application programs via a universal serial bus (USB) cable 30 or other suitable wired or wireless connection. Computing device 28 processes the output of the interactive board 22 and adjusts image data that is output to the projector 38, if required, so that the image presented on the interactive surface 24 reflects pointer activity. In this manner, the interactive board 22, computing device 28 and projector 38 allow pointer activity proximate to the interactive surface 24 to be recorded as writing or drawing or used to control execution of one or more application programs executed by the computing device 28.

The bezel 26 in this embodiment is mechanically fastened to the interactive surface 24 and comprises four bezel segments that extend along the edges of the interactive surface 24. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces extend in a plane generally normal to the plane of the interactive surface 24.

A tool tray 48 is affixed to the interactive board 22 adjacent the bottom bezel segment using suitable fasteners such as for example, screws, clips, adhesive, etc. As can be seen, the tool tray 48 comprises a housing that accommodates a master controller and that has an upper surface configured to define a plurality of receptacles or slots. The receptacles are sized to receive one or more pen tools 40 as well as an eraser tool (not shown) that can be used to interact with the interactive surface 24. Control buttons (not shown) are provided on the upper surface of the housing to enable a user to control operation of the interactive input system 20. Further details of the tool tray 48 are provided in International PCT Application Publication No. WO 2011/085486 filed on Jan. 13, 2011, and entitled “INTERACTIVE INPUT SYSTEM AND TOOL TRAY THEREFOR”.

Imaging assemblies (not shown) are accommodated by the bezel 26, with each imaging assembly being positioned adjacent a different corner of the bezel. Each of the imaging assemblies comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 24 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes IR illumination and appears as a dark region interrupting the bright band in captured image frames.

The imaging assemblies are oriented so that their fields of view overlap and look generally across the entire interactive surface 24. In this manner, any pointer such as for example a user's finger, a cylinder or other suitable object, or a pen or eraser tool lifted from a receptacle of the tool tray 48, that is brought into proximity of the interactive surface 24 appears in the fields of view of the imaging assemblies and thus, is captured in image frames acquired by multiple imaging assemblies. When the imaging assemblies acquire image frames in which a pointer exists, the imaging assemblies convey the image frames to the master controller. The master controller in turn processes the image frames to determine the position of the pointer in (x,y) coordinates relative to the interactive surface 24 using triangulation. The pointer coordinates are then conveyed to the computing device 28 which uses the pointer coordinates to update the display data provided to the projector 38 if appropriate. Pointer contacts on the interactive surface 24 can therefore be recorded as writing or drawing or used to control execution of application programs running on the computing device 28.

The computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) storing machine-executable program code as will be described below, and a system bus coupling the various computer components to the processing unit. The computer may also comprise networking capability using Ethernet, WiFi, and/or other network format, for connection to access shared or remote drives, one or more networked computers, or other networked devices.

The computing device 28 runs a host software application such as SMART Notebook™ offered by SMART Technologies ULC. As is known, during execution, the SMART Notebook™ application provides a graphical user interface comprising a canvas page or palette, that is presented on the interactive surface 24, and on which freeform or handwritten ink objects together with other computer generated objects can be input and manipulated via pointer interaction with the interactive surface 24.

The interactive input system 20 is able to detect passive pointers such as for example, a user's finger, a cylinder or other suitable object as well as passive and active pen tools 40 that are brought into proximity with the interactive surface 24 and within the fields of view of the imaging assemblies.

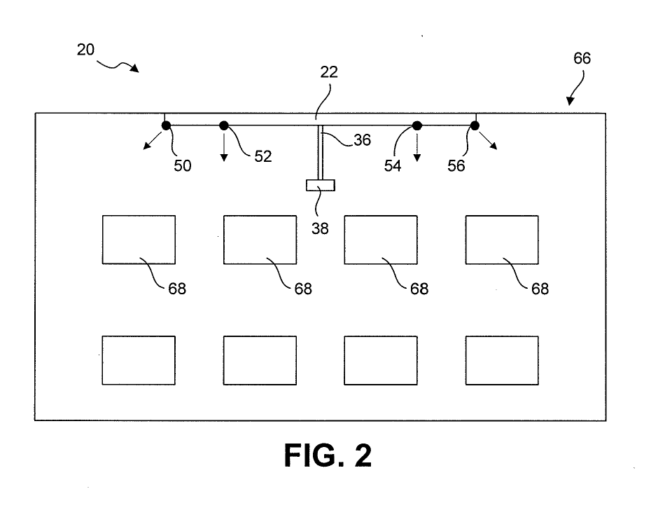

Turning now to both FIGS. 1 and 2, interactive input system 20 also comprises one or more proximity sensors configured to sense the presence of objects, such as one or more users, in proximity with the interactive board 22. The proximity sensors are also in communication with the master controller located within tool tray 48. In this embodiment, the interactive input system 20 comprises a pair of proximity sensors 50 and 56 mounted on an underside of the interactive board 22, near its bottom corners 22a and 22b, respectively, and a pair of proximity sensors 52 and 54 mounted on an underside of the tool tray 48 at spaced locations adjacent the detachable tool tray modules 48a and 48b, respectively. The distance between the sensors 52 and 54 is selected to be greater than the width of an average adult person.

Proximity sensors 50, 52, 54 and 56 may be any kind of proximity sensor known in the art. Several types of proximity sensors are commercially available such as, for example, sonar-based, infrared (IR) optical-based, and CMOS or CCD image sensor-based proximity sensors. In this embodiment, each of the proximity sensors 50, 52, 54 and 56 is a Sharp IR Distance Sensor 2Y0A02 manufactured by Sharp Electronics Corp., which is capable of sensing the presence of objects within a detection range of between about 0.2 m to 1.5 m. As will be appreciated, this detection range is well suited for use of the interactive input system 20 in a classroom environment, for which detection of objects in the classroom beyond this range may be undesirable. However, other proximity sensors may alternatively be used. For example, in other embodiments, each of the proximity sensors may be a MaxBotix EZ-1 sonar sensor manufactured by MaxBotix® Inc., which is capable of detecting the proximity of objects within a detection range of between about 0 m to 6.45 m.

As shown in FIG. 2, interactive input system 20 may be employed in an operating environment 66 in which one or more fixtures 68 are located. In this embodiment, the operating environment 66 is a classroom and the fixtures 68 are desks. However, as will be understood, interactive input system 20 may alternatively be used in other environments. Once the interactive input system 20 has been installed in the operating environment 66, the interactive board 22 is calibrated so as to allow proximity sensors 50, 52, 54 and 56 to sense the presence of the fixtures 68 in their respective detection ranges. Proximity sensors 50, 52, 54 and 56 communicate calibration values to the master controller, which receives the calibration values from each of the proximity sensors and saves the calibration values in memory as a set of individual baseline values.

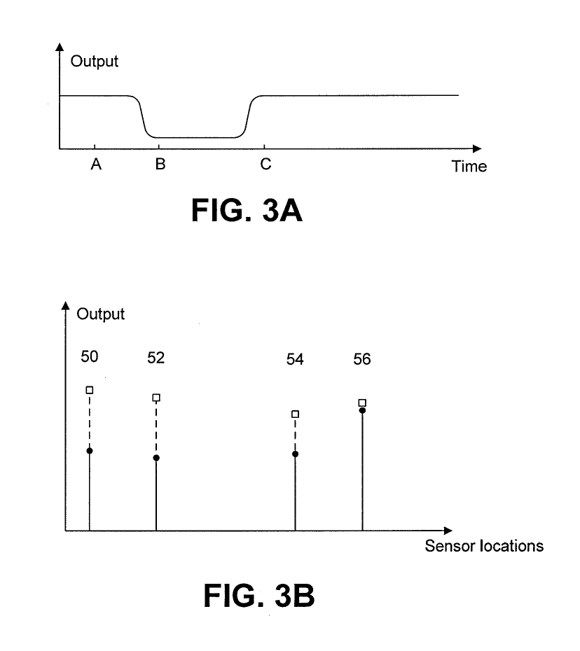

FIG. 3A shows a graphical plot of the typical output of one of the proximity sensors 50, 52, 54 and 56 over a period of time during which an object, such as a user, enters and exits the detection range of the proximity sensor. At times A and C, when the object is not within the detection range of the proximity sensor, the proximity sensor outputs the baseline value determined during calibration. At time B, when the object is within the detection range of the proximity sensor, the proximity sensor outputs a value differing from the baseline value and which represents the existence of the object and the distance between the proximity sensor and the object.

The master controller periodically acquires values from all proximity sensors 50, 52, 54 and 56, and then compares the acquired values to the baseline values determined for each of the proximity sensors during calibration to detect the presence of objects in proximity with interactive board 22. For example, if adjacent proximity sensors output values that are similar or within a predefined threshold of each other, the master controller can determine that the two proximity sensors are detecting the same object. The size of an average user and the known spatial configuration of proximity sensors 50, 52, 54 and 56 may be considered in determining whether one or more users are present. FIG. 3B shows a graphical plot of data obtained from each of the proximity sensors 50, 52, 54 and 56 at a single point in time, where the x-axis represents proximity sensor position along the interactive board 22. The circle symbols indicate the value output by each of the proximity sensors, while the square symbols indicate the baseline value for each of the proximity sensors. In this figure, the values output by proximity sensors 50, 52 and 54 are similar. As proximity sensors 50 and 52 are closely spaced, the master controller will determine that proximity sensors 50 and 52 are both sensing a first user positioned at a location between the proximity sensors 50 and 52, and spaced from the interactive board 22 by a distance generally corresponding to an average of the outputs of proximity sensors 50 and 52. As proximity sensor 54 is spaced from proximity sensors 50 and 52, the master controller will also determine that proximity sensor 54 is detecting the presence of a second user in front of the interactive board 22. As the output of proximity sensor 56 does not differ significantly from the baseline value for that proximity sensor, the master controller determines that the second user is located only in front of proximity sensor 54, and not in front of proximity sensor 56. In this manner, the master controller identifies the number and respective locations of one or more users relative to the interactive board 22, and therefore relative to the interactive surface 24. The master controller in turn communicates the number of detected objects in proximity with the interactive board 24 and for each such detected object, a position and distance value representing the position of the object relative to the interactive board 22 and the distance of the object from the interactive board 22 to the computing device 28. Computing device 28 stores this information in memory for processing as will be described.

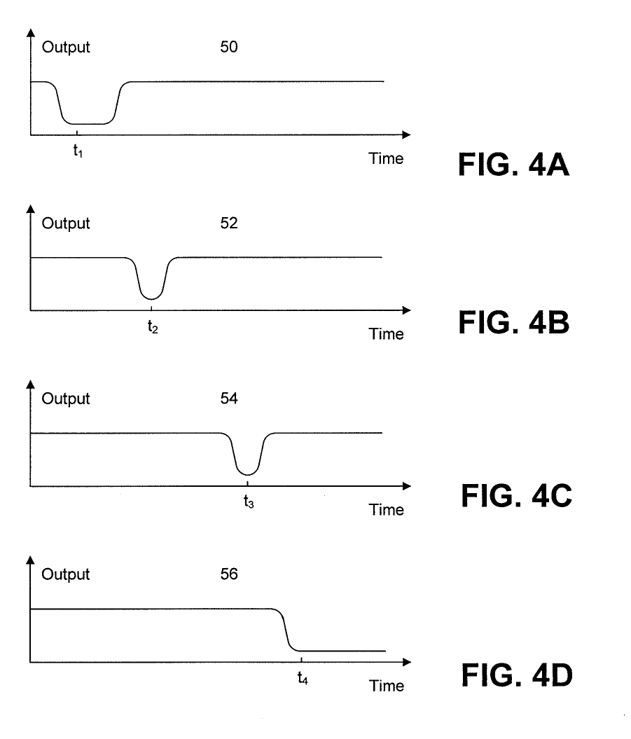

The computing device 28 can use the object number, position and distance information output by the master controller that is generated in response to the output of the proximity sensors 50, 52, 54 and 56 to detect and monitor movement of objects relative to interactive board 22. FIGS. 4A to 4D show graphical plots of output from each of the proximity sensors as a function of time. In this example, a user is sensed by proximity sensors 50, 52, 54 and 56 in a sequential manner generally at times t₁, t₂, t₃ and t₄, respectively. Based on this data and on the known spatial configuration of proximity sensors 50, 52, 54 and 56, the computing device 28 is able to determine that the user is moving from one side of the interactive board 22 to the other. This movement can be utilized by the computing device 28 as a form of user input, as will be further described below.

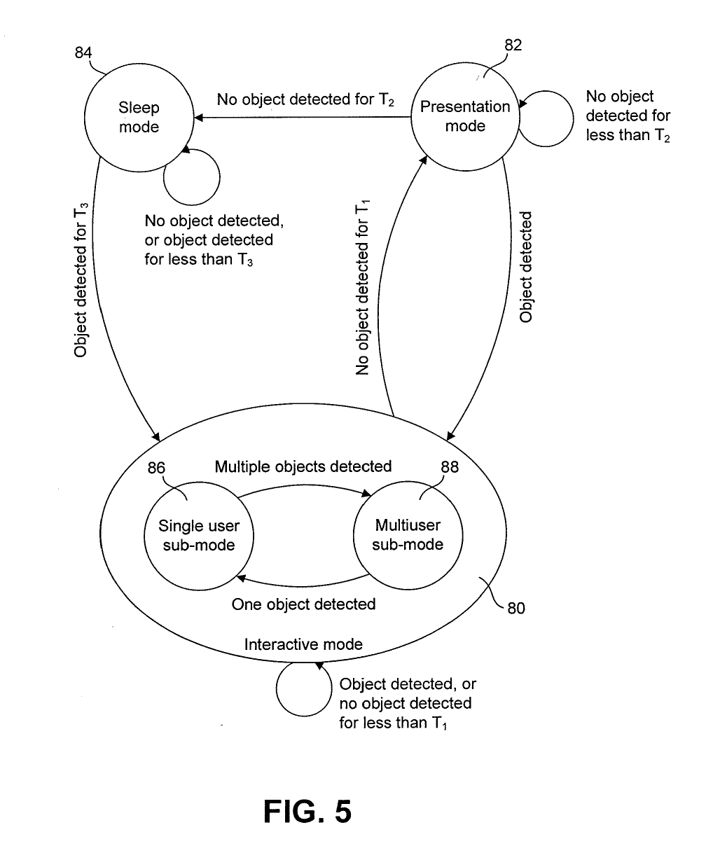

Interactive input system 20 has several different operating modes, as schematically illustrated in FIG. 5. In this embodiment, these modes of operation comprise an interactive mode 80, a presentation mode 82, and a sleep mode 84. In interactive mode 80, the computing device 28 provides display data to the projector 38 so that display content with which one or more users may interact is presented on the interactive surface 24 of the interactive board 22. The display content may include any of, for example, a SMART Notebook™ page, a presentation slide, a document, and an image, and also may include one or more user interface (UI) components. The UI components are generally selectable by a user through pointer interaction with the interactive surface 24. The UI components may be any of, for example, menu bars, toolbars, toolboxes, icons, page thumbnail images, etc.

Interactive mode 80 has two sub-modes, namely a single user sub-mode 86 and a multi-user sub-mode 88. Interactive input system 20 alternates between sub-modes 86 and 88 according to the number of users detected in front of interactive board 22 based on the output of proximity sensors 50, 52, 54 and 56. When only a single user is detected, interactive input system 20 operates in the single user sub-mode 86, in which the display content comprises only one set of UI components. When multiple users are detected, interactive input system 20 operates in multi-user sub-mode 88, in which the display content comprises a set of UI components for each detected user, with each set of UI components being presented at respective locations on interactive surface 24 near each of the detected locations of the users.

If no object is detected over a period of time T₁ while the interactive input system 20 is in interactive mode 80, the interactive input system 20 enters the presentation mode 82. In the presentation mode 82, the computing device 28 provides display data to the projector 38 so that display content is presented on interactive board 22 in full screen and UI components are hidden. During the transition from the interactive mode 80 to the presentation mode 82, the computing device 28 stores the display content that was presented on the interactive surface 24 immediately prior to the transition in memory. This stored display content is used for display set-up when the interactive input system 20 again enters the interactive mode 80 from either the presentation mode 82 or the sleep mode 84. The stored display content may comprise any customizations made by the user, such as, for example, any arrangement of moveable icons made by the user, and any pen colour selected by the user.

If an object is detected while the interactive input system 20 is in the presentation mode 82, the interactive input system enters the interactive mode 80. Otherwise, if no object is detected over a period of time T₂ while the interactive input system 20 is in the presentation mode 82, the interactive input system 20 enters the sleep mode 84. In this embodiment, as much of the interactive input system 20 as possible is shut off during the sleep mode 84 so as to save power, with the exception of circuits required to “wake up” the interactive input system 20, which include circuits required for the operation and monitoring of proximity sensors 52 and 54. If an object is detected for a time period that exceeds a threshold time period T₃ while the interactive input system is in the sleep mode 84, the interactive input system 20 enters the interactive mode 80. Otherwise, the interactive input system 20 remains in the sleep mode 84.

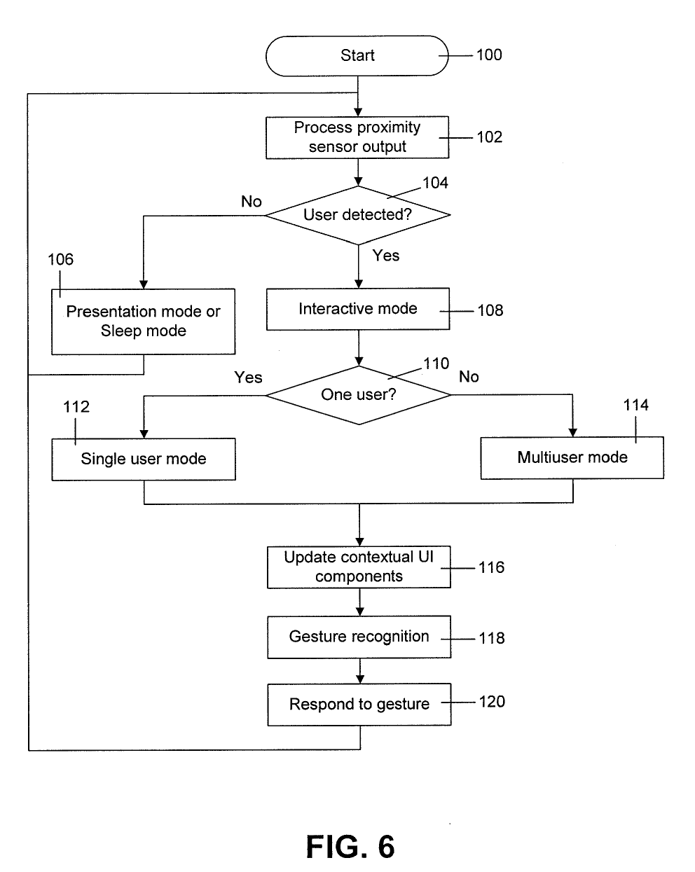

FIG. 6 is a flowchart showing steps in a method of operation of interactive input system 20. It will be understood that, in the following description, display content and/or interactive input system settings are updated when the interactive input system transitions between modes, as described above with reference to FIG. 5. After the interactive input system 20 starts (step 100), it automatically enters the presentation mode 82. The master controller in turn monitors the output of proximity sensors 50, 52, 54 and 56 to determine if users are proximate the interactive board 22 (step 102). During operation, if no user is detected over period of time T₁ (step 104), the interactive input system 20 enters the presentation mode 82 (step 106), or remains in the presentation mode 82 if it is already in this mode, and returns to step 102. If while in the presentation mode 82 no user is detected over a time period that exceeds the threshold time period T₂ (step 104), the interactive input system 20 enters the sleep mode 84 (step 106), and returns to step 102.

If a user is detected at step 104 over a period of time exceeding T₃, the computing device 28, in response to the master controller output, conditions the interactive input system 20 to the interactive mode (step 108) and determines the total number of detected users (step 110). If only one user is detected, the interactive input system 20 enters the single user sub-mode 86 (step 112), or remains in the single user sub-mode 86 if it is already in this sub-mode. Otherwise, the interactive input system 20 enters the multi-user sub-mode 88 (step 114). The computing device 28 then updates the display data provided to the projector 38 so that the UI components presented on the interactive surface 24 of interactive board 22 (step 116) are in accordance with the number of detected users.

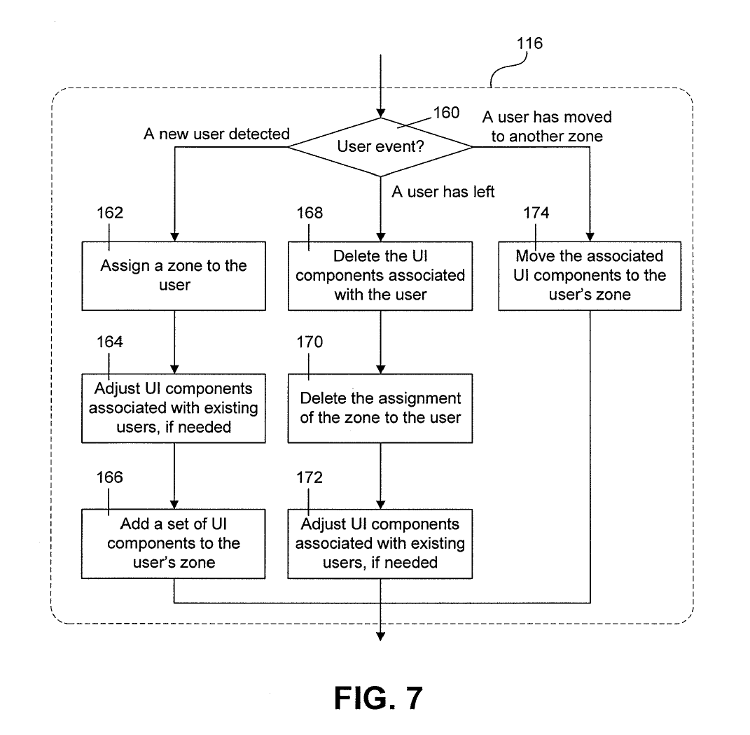

FIG. 7 is a flowchart of steps used for updating UI components in step 116. The computing device 28 first compares the output of the master controller to previous master controller output stored in memory to identify a user event (step 160). A user event includes any of the appearance of a user, the disappearance of a user, and movement of a user. The interactive surface 24 may be divided into a plurality of zones, on which display content can be displayed for a respective user assigned to that zone when the interactive input system 20 is in the multi-user mode. In this embodiment, the interactive surface 24 has two zones, namely a first zone which occupies the left half of the interactive surface 24 and a second zone which occupies the right half of the interactive surface 24. If the appearance of a user is detected, the computing device 28 assigns a nearby available zone of the interactive surface 24 to the new user (step 162). The UI components associated with existing users are then adjusted (step 164), which involves the UI components being resized and/or relocated so as to make available screen space on interactive surface 24 for the new user. A new set of UI components are then added to the zone assigned to the new user (step 166).

If the disappearance of a user is detected at step 160, the UI components previously assigned to the former user are deleted (step 168), and the assignment of the zone to that former user is also deleted (step 170). The deleted UI components may be stored by the computing device 28, so that if the appearance of a user is detected near the deleted zone within a time period T₄, that user is assigned to the deleted zone (step 162) and the stored UI components are displayed (step 166). In this embodiment, the screen space of the deleted zone is assigned to one or more remaining users. For example, if one of two detected users disappears, the entire interactive surface 24 is then assigned to the remaining user. Following step 170, the UI components associated with remaining user or users are adjusted accordingly (step 172).

If it is determined at step 160 that a user has moved away from a first zone assigned thereto and towards a second zone, the assignment of the first zone is deleted and the second zone is assigned to the user. The UI components associated with the user are moved to the second zone (step 174).

Returning to FIG. 6, following step 116 the computing device 28 then analyzes the output of the master controller generated in response to the output of the proximity sensors 50, 52, 54 and 56 to determine if any of the detected objects are gesturing (step 118). If so, the computing device 28 updates the display data provided to the projector 38 so that the display content presented on the interactive surface 24 of interactive board 22 reflects the gesture activity (step 120) as will be described. Following step 120, the interactive input system 20 then returns to step 102 and the master controller continues to monitor the output of proximity sensors 50, 52, 54 and 56 to detect objects.

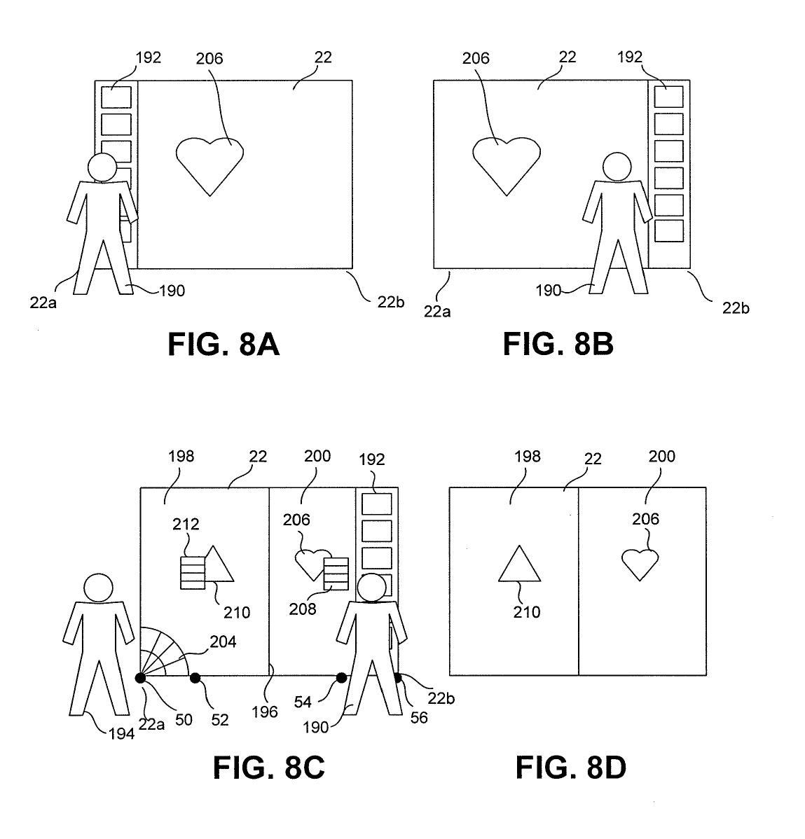

FIGS. 8A to 8D illustrate examples of configurations of display content presented on the interactive surface 24 of interactive board 22. In FIG. 8A, in response to proximity sensor output, the master controller detects a single user 190 located near first corner 22a of interactive board 22. Accordingly, UI components in the form of page thumbnail images 192 are displayed vertically along the left edge of the interactive surface 24. Here, the page thumbnail images 192 are positioned so as to allow the user to easily select one of the thumbnail images 192 by touch input, and without requiring the user 190 to move from the illustrated location. As only a single user is detected, the entire interactive surface 24 is assigned to the user 190. In FIG. 8B, the interactive input system 20 detects that the user 190 has moved towards corner 22b of interactive board 22. Consequently, the page thumbnail images 192 are moved and positioned vertically along the right edge of the interactive surface 24.

In FIG. 8C, in response to proximity sensor output, the master controller detects the appearance of a second user 194 located near first corner 22a of interactive board 22. As a result, the interactive input system 20 enters the multi-user sub-mode 88, and accordingly the computing device 28 divides the interactive surface 24 into two zones 198 and 200, and assigns these zones to users 194 and 190, respectively. A separation line 196 is displayed on the interactive surface 24 to indicate the boundary between zones 198 and 200. The display content for user 190, which includes graphic object 206 and UI components in the form of thumbnail images 192, is resized proportionally within zone 200. In this example, user 190 is sensed by both proximity sensors 54 and 56, and therefore the computing device 28 determines that first user 190 is located between proximity sensors 54 and 56, as illustrated. Accordingly, interactive input system 20 displays thumbnail images 192 in full size along a vertical edge of interactive board 22. A new set of UI components in the form of thumbnail images 204 are added and assigned to user 194, and are displayed in zone 198. In this example, user 194 is detected by proximity sensor 50, but not by proximity sensor 52, and therefore the computing device 28 determines that first user 194 is located to the left of proximity sensor 50, as illustrated. Accordingly, interactive input system 20 displays thumbnail images 204 in a clustered arrangement generally near first corner 22a. In the embodiment shown, user 194 has created graphic object 210 in zone 198.

Users may inject input into the interactive input system 20 by bringing one or more pointers into proximity with the interactive surface 24. As will be understood by those of skill in the art, such input may be interpreted by the interactive input system 20 in several ways, such as for example digital ink or commands. In this embodiment, users 190 and 194 have injected input near graphic objects 206 and 210 so as to instruct the computing device 28 to display respective pop-up menus 208 and 212 adjacent the graphic objects. Pop-up menus 208 and 212 in this example comprise additional UI components displayed within boundaries of each respective zone. In this embodiment, the display content that is presented in each of the zones is done so independently from that of the other zone.

In FIG. 8D, in response to the proximity sensor output, the master controller no longer detects the presence of any users near the interactive board 22, and as a result, the computing device 28 determines that users 194 and 196 have moved away from the interactive board 22. After time period T₁ has passed, the interactive input system 20 enters the presentation mode 82, wherein presentation pages are displayed within each of the zones 198 and 200. The presentation pages include graphic objects 206 and 210, but do not include the thumbnail images 192 and 204.

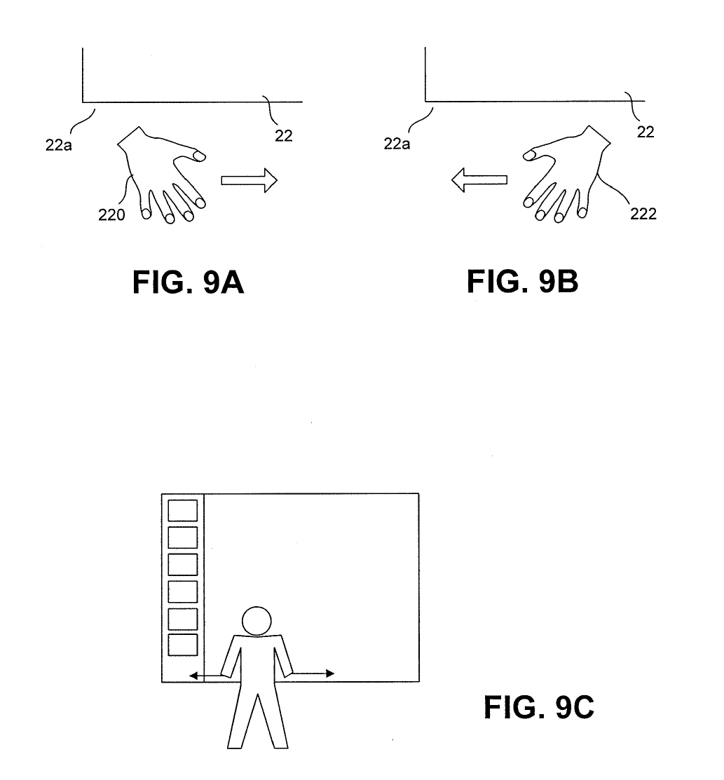

The interactive input system 20 is also able to detect hand gestures made by users within the detection ranges of proximity sensors 50, 52, 54 and 56. FIGS. 9A to 9C show examples of hand gestures that are recognizable by the interactive input system 20. FIG. 9A shows a user's hand 220 being waved in a direction generally toward the centre of interactive surface 24. This gesture is detected by the computing device 28 following processing of the master controller output and, in this embodiment, is assigned the function of forwarding to a new page image for presentation on the interactive surface 24. Similarly, FIG. 9B shows a user's hand 222 being waved in a direction generally away from the centre of interactive board 22. In this embodiment, this gesture is assigned the function of returning to a previous page image for presentation on the interactive surface 24. FIG. 9C shows a user moving hands away from each other. This gesture is detected by the computing device 28 and, in this embodiment, is assigned the function of zooming into the current page image presented on the interactive surface 24. As will be appreciated, in other embodiments these gestures may be assigned other functions. For example, the gesture illustrated in FIG. 9C may alternatively be assigned the function of causing the interactive input system 20 to enter the presentation mode 82.

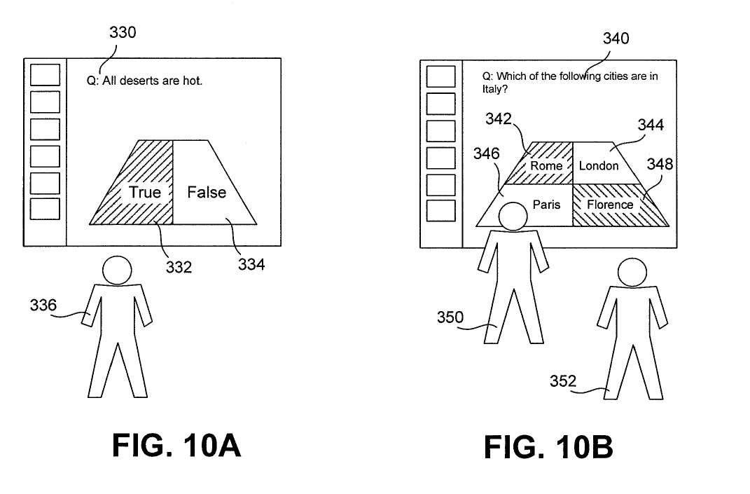

As will be appreciated, interactive input system 20 may run various software applications that utilize output from proximity sensors 50, 52, 54 and 56. For example, FIG. 10A shows an application in which a true/false question 330 is presented on interactive surface 24. Possible responses are also presented on interactive surface 24 as graphic objects 332 and 334. The area generally in front of interactive board 22 and within the detection ranges of proximity sensors 50, 52, 54 and 56 is divided into a plurality of regions (not shown) associated with the graphic objects 332 and 334. A user 336 may enter a response to the question 330 by standing within one of the regions so that the user is sensed by the appropriate proximity sensor and detected by the master controller. In the embodiment shown, the user 336 has selected the response associated with graphic object 332, which causes the computing device 28, in response to master controller output, to update the display data provided to the projector 38 so that the object 332 is highlighted. This selection is confirmed by the computing device 28 once the user 336 remains at this location for a predefined time period. Depending on the specific application being run, the computing device 28 may then determine whether the response entered by the user is correct or incorrect. In this manner, the interactive input system 20 determines a processing result based on the output of the proximity sensors.

FIG. 10B shows another application for use with interactive input system 20, in which a multiple choice question 340 is presented to users 350 and 352. Four responses in the form of graphic objects 342, 344, 346 and 348 are displayed on the interactive surface 24. In this embodiment, the area generally in front of interactive board 22 and within the detection ranges of proximity sensors 50, 52, 54 and 56 is divided into four regions (not shown), with each region being associated with one of the graphic objects 342, 344, 346 and 348. In this embodiment, the regions are arranged similarly to the arrangement of graphic objects 342, 344, 346 and 348, and are therefore arranged as a function of distance from the interactive surface 24. The computing device 28 is configured to determine from the master controller output the respective locations of one or more users as a function of distance from the interactive board 24, whereby each location represents a two-dimensional co-ordinate within the area generally in front of interactive board 22. In this embodiment, a response to the question needs to be entered by both users. Here, users 350 and 352 each enter their response by standing within one of the regions for longer than a threshold time period, such as for example three (3) seconds so that the users are sensed by the appropriate proximity sensors and detected by the master controller. Depending on the specific application being run, the computing device 28 may combine the responses entered by the users to form a single response to the question, and then determine whether the combined response is correct or incorrect. In this manner, the interactive input system 20 again determines a processing result based on the output of the proximity sensors.

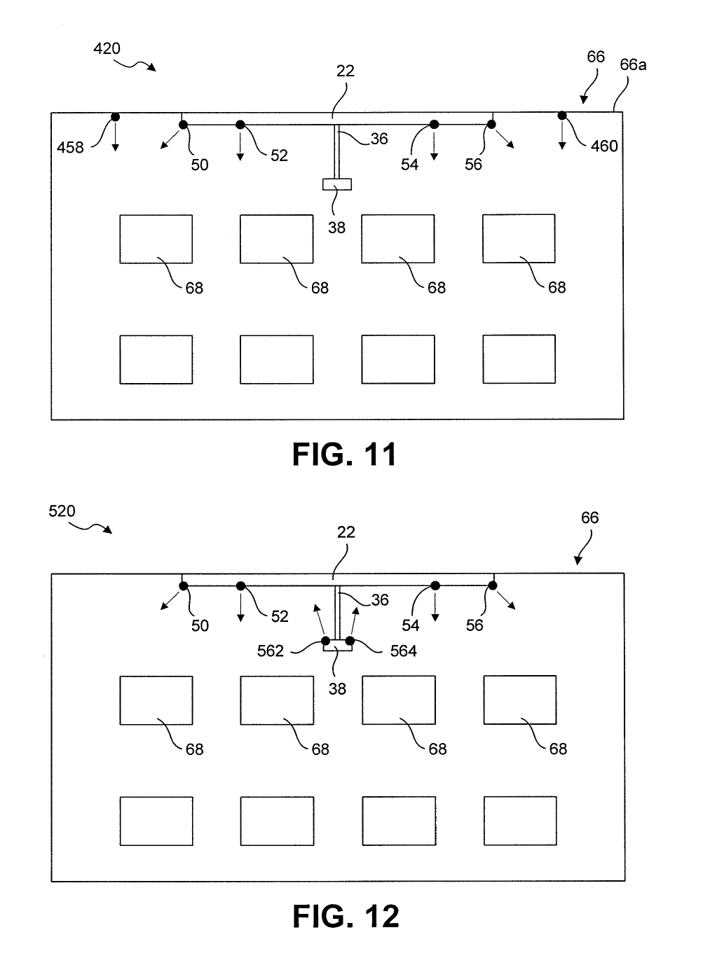

As will be understood, the number and configuration of the proximity sensors is not limited to those described above. For example, FIG. 11 shows another embodiment of an interactive input system installed in an operating environment 66, which is generally indicated using reference numeral 420. Interactive input system 420 is similar to interactive input system 20 described above with reference to FIGS. 1 to 10, however interactive input system 420 comprises additional proximity sensors 458 and 460 that are installed on the wall 66a near opposite sides of the interactive board 22. Proximity sensors 458 and 460 communicate with the master controller via either wired or wireless connections. As compared to interactive input system 20 described above, proximity sensors 458 and 460 generally provide an extended range of object detection, and thereby allow interactive input system 420 to better determine the locations of objects located adjacent the periphery of the interactive board 22.

Still other configurations are possible. For example, FIG. 12 shows another embodiment of an interactive input system installed in an operating environment 66, which is generally indicated using reference numeral 520. Interactive input system 520 is again similar to interactive input system 20 described above with reference to FIGS. 1 to 10, however interactive input system 520 comprises additional proximity sensors 562 and 564 mounted on projector boom 32 adjacent the projector 38. Proximity sensors 562 and 564 communicate with the master controller via either wired or wireless connections. In this embodiment, proximity sensors 562 and 564 face downwardly towards the interactive board 22. As compared to interactive input system 20 described above, proximity sensors 562 and 564 generally provide an extended range of object detection in an upward direction.

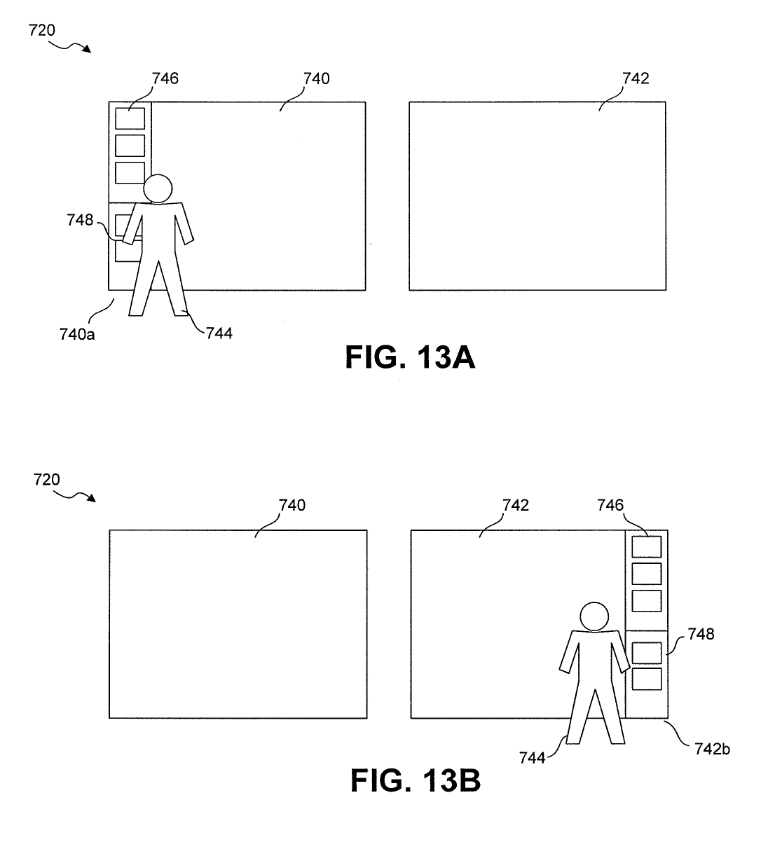

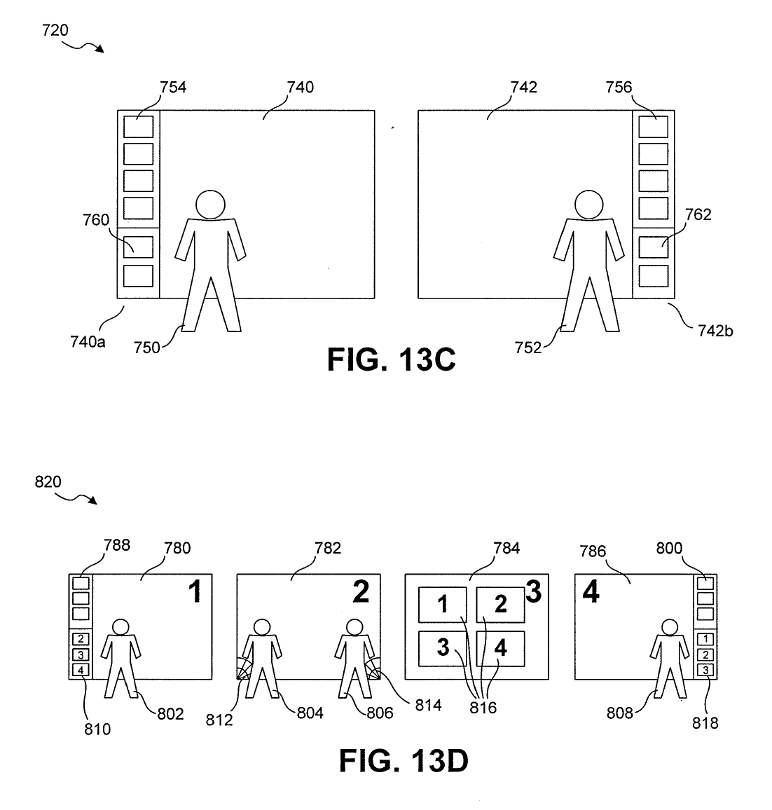

FIGS. 13A to 13D show another embodiment of an interactive input system, which is generally indicated using reference numeral 720. Interactive input system 720 is again similar to interactive input system 20 described above with reference to FIGS. 1 to 10, however instead of comprising a single interactive board, interactive input system 720 comprises a plurality of interactive boards, in this example, two (2) interactive boards 740 and 742. Each of the interactive boards 740 and 742 is similar to the interactive board 22 and thus comprises proximity sensors (not shown) arranged in a similar manner as proximity sensors 50, 52, 54 and 56, shown in FIG. 1. In FIG. 13A, in response to master controller output, the computing device 28 of interactive input system 720 determines that a single user 744 is located near first corner 740a of interactive board 740. Accordingly, UI components in the form of page thumbnail images 746 and 748 are displayed along the left edge of the interactive surface of interactive board 740. In the embodiment shown, page thumbnail images 746 are presentation slides, and page thumbnail images 748 are images of slides recently displayed on the interactive surfaces of interactive boards 740 and 742. Page thumbnail images 746 and 748 may be selected by the user 744 so as to display full size pages on the interactive surfaces of the interactive boards 740 and 742. Similar to the embodiments described above, page thumbnail images 746 and 748 are positioned so as to allow the user 744 to easily select one of the thumbnail images 746 and 748 by touch input, and without requiring the user 744 to move from their current location. In FIG. 13B, in response to master controller output, the computing device 28 of interactive input system 720 determines that the user 744 has moved towards second corner 742b of interactive board 742. Consequently, the page thumbnail images 746 and 748 are displayed along the right edge of the interactive surface of the interactive board 742.

In FIG. 13C, in response to the master controller output, the computing device 28 of the interactive input system 720 determines that a first user 750 is located near the first corner 740a of interactive board 740 and that a second user 752 is located near the second corner 742b of interactive board 742. As a result, interactive input system 720 enters the multi-user sub-mode, and accordingly each of the interactive boards 740 and 742 is assigned to a respective user. On interactive board 740, display content comprising UI components in the form of thumbnail images 754 of presentation slides, together with thumbnail images 760 of display content recently displayed on interactive board 740, is presented. Similarly, on interactive board 742, display content comprising UI components in the form of thumbnail images 756 of presentation slides, together with thumbnail images 762 of the display content recently displayed on interactive board 742, is presented.

Still other multiple interactive board configurations are possible. For example, FIG. 13D shows another embodiment of an interactive input system, which is generally indicated using reference numeral 820. Interactive input system 820 is similar to interactive input system 720; however instead of comprising two (2) interactive boards, interactive input system 820 comprises four (4) interactive boards 780, 782, 784 and 786. Each of the interactive boards 780, 782, 784 and 786 is again similar to the interactive board 22 and thus comprises proximity sensors (not shown) arranged in a similar manner as proximity sensors 50, 52, 54 and 56 shown in FIG. 1. In the example shown, in response to master controller output, the computing device 28 of interactive input system 820 determines that a single user 802 is located in front of interactive board 780, and accordingly assigns the entire interactive surface of interactive board 780 to user 802. UI components in the form of thumbnail images 788 of display content, together with thumbnail images 810 of the current display content of interactive boards 782, 784 and 786, are all displayed on interactive board 780 at a position near user 802. In response to master controller output, the computing device 28 of interactive input system 820 also determines that two users, namely first and second users 804 and 806 are located near opposite sides of interactive board 782. As a result, the computing device 28 of interactive input system 820 assigns each of the two zones (not shown) within interactive board 782 to a respective user 804 and 806. Unlike the embodiment shown in FIG. 8C, no separation line is shown between the two zones. UI components in the form of page thumbnail images 812 and 814 of display content, and of the current display content of interactive boards 780, 784 and 786, are presented in each of the two zones. The interactive input system 820 has not detected a user near interactive board 784, and accordingly has entered the presentation mode with regard to interactive surface 784. As a result, thumbnail images 816 of display content of all of the interactive boards 780, 782, 784 and 786, are presented. In response to master controller output, the computing device 28 of interactive input system 820 further determines that a single user 808 is located in front of interactive board 786, and accordingly assigns interactive board 786 to user 808. UI components in the form of thumbnail images 800 of display content, together with thumbnail images 818 of the current display content of interactive boards 780, 782 and 784, are all presented on interactive board 786.

Although in the embodiments described above, the interactive input systems comprise imaging assemblies positioned adjacent corners of the interactive boards, in other embodiments the interactive input systems may comprise more or fewer imaging assemblies arranged about the periphery of the interactive surfaces or may comprise one or more imaging assemblies installed adjacent the projector and facing generally towards the interactive surfaces. Such a configuration of imaging assemblies is disclosed in U.S. Pat. No. 7,686,460 to Holmgren, et al., assigned to SMART Technologies ULC, the entire content of which is fully incorporated herein by reference.

Although in embodiments described above the proximity sensors are in communication with the master controller housed within the tool tray, other configurations may be employed. For example, the master controller need not be housed within the tool tray. In other embodiments, the proximity sensors may alternatively be in communication with a separate controller that is not the master controller, or may alternatively be in communication directly with the computing device 28. Also, the master controller or separate controller may be responsible for processing proximity sensor output to recognize gestures, user movement, etc., and provide resultant data to the computing device 28. Alternatively, the master controller or separate controller may simply pass proximity sensor output directly to the computing device 28 for processing.

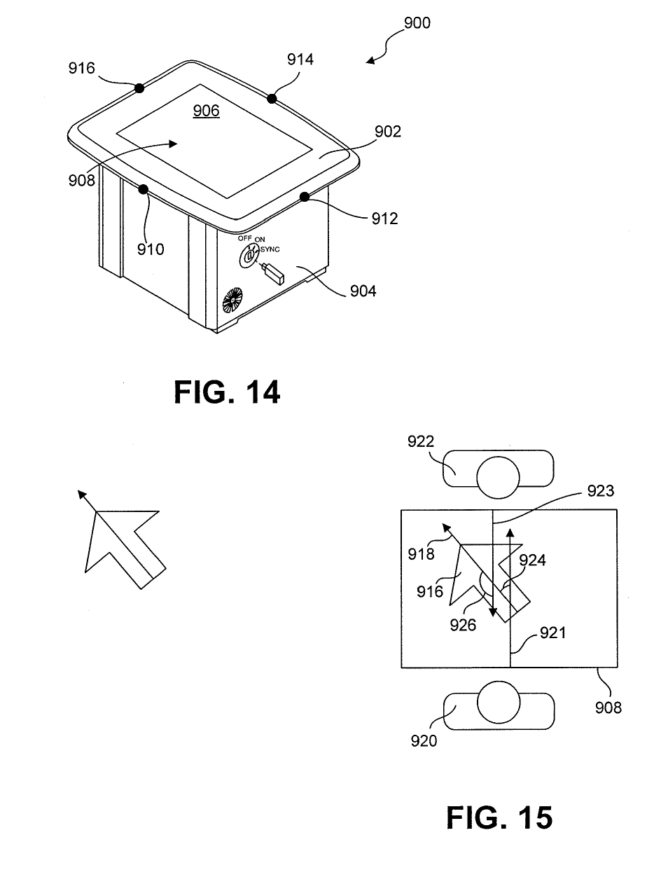

FIG. 14 shows yet another embodiment of an interactive input system, and which is generally indicated using reference numeral 900. Interactive input system 900 is in the form of an interactive touch table. Similar interactive touch tables have been described, for example, in U.S. Patent Application Publication No. 2010/0079409 to Sirotich, et al., assigned to SMART Technologies ULC, the entire content of which is incorporated herein by reference. Interactive input system 900 comprises a table top 902 mounted atop a cabinet 904. In this embodiment, cabinet 904 sits atop wheels, castors or the like that enable the interactive input system 900 to be easily moved from place to place as desired. Integrated into table top 902 is a coordinate input device in the form of a frustrated total internal reflection (FTIR) based touch panel 906 that enables detection and tracking of one or more pointers, such as fingers, pens, hands, cylinders, or other objects, applied thereto.

Cabinet 904 supports the table top 902 and touch panel 906, and houses processing structure (not shown) executing a host application and one or more application programs. Image data generated by the processing structure is displayed on the touch panel 906 allowing a user to interact with the displayed image via pointer contacts on interactive display surface 908 of the touch panel 906. The processing structure interprets pointer contacts as input to the running application program and updates the image data accordingly so that the image displayed on the display surface 908 reflects the pointer activity. In this manner, the touch panel 906 and processing structure allow pointer interactions with the touch panel 906 to be recorded as handwriting or drawing or used to control execution of the running application program.

The processing structure in this embodiment is a general purpose computing device in the form of a computer. The computer comprises for example, a processing unit, system memory (volatile and/or non-volatile memory), other non-removable or removable memory (a hard disk drive, RAM, ROM, EEPROM, CD-ROM, DVD, flash memory, etc.) and a system bus coupling the various computer components to the processing unit.

Interactive input system 900 comprises proximity sensors positioned about the periphery of the table top 902. In this embodiment, proximity sensors 910, 912, 914 and 916 are positioned approximately midway along the four edges of table top 902, as illustrated. As will be understood, the proximity sensors 910 to 916, together with the supporting circuitry, hardware, and software, as relevant to the purposes of proximity detection, are generally similar to that of the interactive input system 20 described above with reference to FIGS. 1 to 10. Similarly, interactive input system 900 utilizes interactive, presentation and sleep modes 80, 82, and 84, respectively, as described above for interactive input system 20. The interactive input system 900 uses object proximity information to assign workspaces, adjust contextual UI components and recognize gestures in a manner similar to that described above. The interactive input system 900 also uses object proximity information to properly orient images displayed on the display surface 908, and/or as answer input to presented questions.

FIG. 15 shows an example of display content comprising an image 916 presented on the display surface 908 of interactive input system 900. Image 916 has an upright direction 918 associated with it that is recognized by the interactive input system 900. In the embodiment shown, in response to the proximity sensor output, the processing structure of the interactive input system 900 detects two users 920 and 922. Based on the known spatial configuration of proximity sensors 910, 912, 914 and 916, the processing structure of interactive input system 900 assigns each of users 920 and 922 respective viewing directions 921 and 923 generally facing display surface 908, as illustrated. The processing structure of the interactive input system 900 then reorients the image 916 to an orientation such that image 916 is easily viewable to users 920 and 922. In the embodiment illustrated, the processing structure of the interactive input system 900 calculates an angle 924 between viewing direction 921 and upright direction 918, and an angle 926 between viewing direction 923 and upright direction 918. Having calculated these angles, the processing structure of the interactive input system 900 then determines an orientation for image 916 having a new upright direction (not shown), for which the largest of all such angles calculated based on new upright direction is generally reduced, if possible, and with the constraint that new upright direction is parallel with a border of display surface 908. For the embodiment shown, angles 924 and 926 calculated based on new upright direction would be equal or about equal. The image is then displayed (not shown) on display surface 908 in the orientation having the new upright direction.

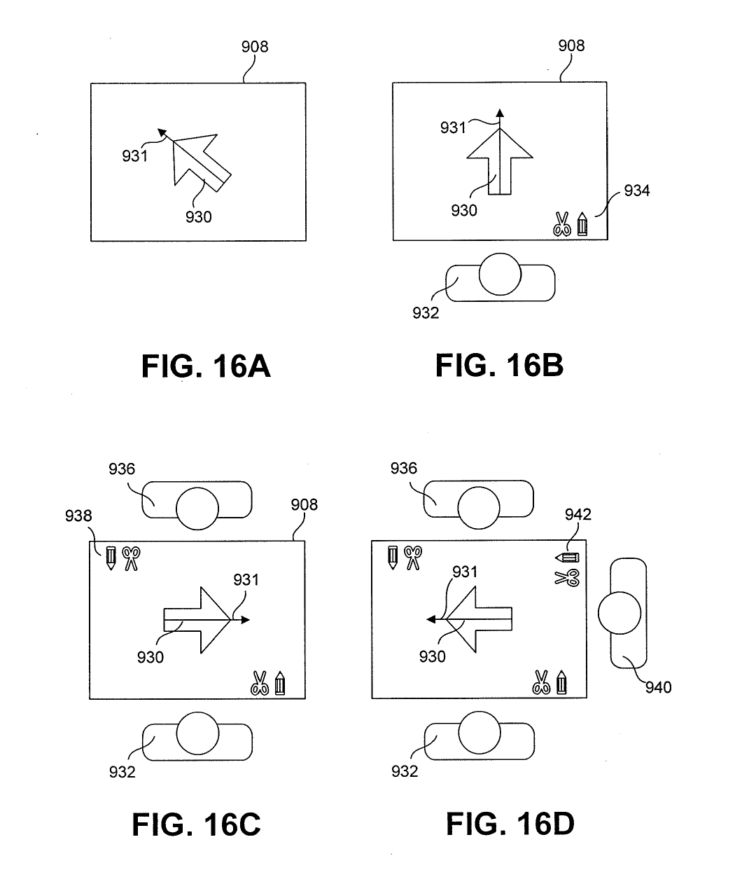

FIGS. 16A to 16D show several examples of display content for use with interactive input system 900. FIG. 16A shows an image 930 having an upright direction 931 displayed on display surface 908. In the embodiment shown, in response to the proximity sensor output, the processing structure of interactive input system 900 does not detect the presence of any users, and accordingly the interactive input system 900 is in the presentation mode. In FIG. 16B, in response to the proximity sensor output, the processing structure of interactive input system 900 detects the appearance of a user 932, and therefore the interactive input system enters the interactive mode. The processing structure of interactive input system 900 in turn reorients image 930 so that it appears as upright to user 932. A set of UI components in the form of tools 934 is added and displayed adjacent a corner of display surface 908 near user 932.

In this embodiment, having detected the presence of only a single user 932, the interactive input system 900 limits the maximum number of simultaneous touches that can be processed to ten (10). Here, the interactive input system only processes the first ten (10) simultaneous touches and disregards any other touches that occur while the calculated touches are still detected on display surface 908 and until the detected touches are released. In some further embodiments, when more than ten (10) touches are detected, the interactive input system determines that touch input detection errors have occurred, such as by, for example, multiple contacts per finger or ambient light interference, and automatically recalibrates the interactive input system to reduce the touch input detection error. In some further embodiments, the interactive input system displays a warning message to prompt users to properly use the interactive input system, for example, to warn users not to bump fingers against the display surface 908.

In this embodiment, “simultaneous touches” refers to situations when the processing structure of the interactive input system samples image output and more than one touch is detected. As will be understood, the touches need not necessarily occur at the same time and, owing to the relatively high sampling rate, there may be a scenario in which a new touch occurs before one or more existing touches are released (i.e., before the fingers are lifted). For example, at a time instant t₁, there may be only one touch detected. At a subsequent time instant t₂, the already-detected touch may still exist while a new touch is detected. At a further subsequent time instant t₃, the already-detected two touches may still exist while a further new touch is detected. In this embodiment, the interactive input system will continue detecting touches until ten (10) simultaneous touches are detected.

In FIG. 16C, in response to proximity sensor output, the processing structure of interactive input system detects the appearance of a second user 936. As a result, the processing structure of interactive input 900 reorients image 930 to an orientation that is suitable for both users 932 and 936. A set of UI components in the form of tools 938 is added and displayed at a corner of display surface 908 near user 936. In this multi-user environment, the interactive input system 900 limits the maximum number of simultaneous touches to twenty (20).

In FIG. 16D, in response to proximity sensor output, the processing structure of interactive input system 900 detects a third user 940, and reorients image 930 to an orientation that is suitable for all users 932, 936 and 940. A set of tools 942 is provided to user 940 at an adjacent corner. A set of UI components in the form of tools 942 is added and displayed at a corner of display surface 908 near user 940. In this environment, the interactive input system 900 limits the maximum number of simultaneous touches to thirty (30).

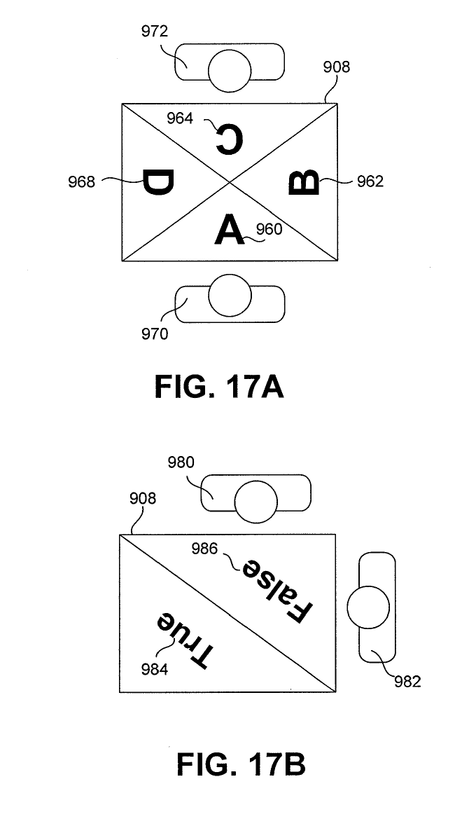

Similar to interactive input system 20 described above, interactive input system 900 may run various software applications that utilize output from proximity sensors 910, 912, 914 and 916 as input for running application programs. For example, FIG. 17A shows an application program being run on interactive input system 900 in which a multiple choice question (not illustrated) is presented to users 970 and 972. Four responses in the form of graphic objects 960, 962, 964 and 968 to the multiple choice question are displayed on the display surface 908. Any of users 970 and 972 may enter a response by standing near one of the graphic objects 960, 962, 964 and 968 and within detection range of the corresponding proximity sensor 910, 912, 914 and 916 for a longer than a predefined time period.

FIG. 17B shows another application program being run on interactive input system 900 in which a true/false question (not shown) is presented to users 980 and 982. Two responses in the form of graphic objects 984 and 986 are displayed on the display surface 908. In this embodiment, the question needs to be answered collaboratively by both users. Users 980 and 982 together enter a single response by both standing near the graphic object corresponding to their response for longer than a predefined time period. As illustrated, interactive input system 900 also has reoriented graphic objects 984 and 986 to a common orientation that is suitable for both users 980 and 982.

Although in some embodiments described above the interactive input system determines an orientation for an image having a new upright direction with a constraint that the new upright direction is parallel with a border of display surface, in other embodiments, the new upright direction may alternatively be determined without such a constraint.

Although in some embodiments described above the interactive input system comprises an interactive board having four (4) proximity sensors along the bottom side thereof, the interactive input system is not limited to this number or arrangement of proximity sensors, and in other embodiments, the interactive input system may alternatively comprise any number and/or arrangement of proximity sensors.

Although in some embodiments described above the interactive input system comprises a sleep mode in which the interactive input system is generally turned off, with the exception of “wake-up” circuits, in other embodiments, the interactive input system may alternatively display content such as advertising or a screen saver during the sleep mode. While in the sleep mode, the output from only some proximity sensors or the output from all of the proximity sensors may be monitored to detect the presence of an object which causes the interactive input system to wake-up.

Although in some embodiments described above the interactive input system enters the interactive mode after the interactive input system starts, in other embodiments, the interactive input system may alternatively enter either the presentation mode or the sleep mode automatically after the interactive input system starts.

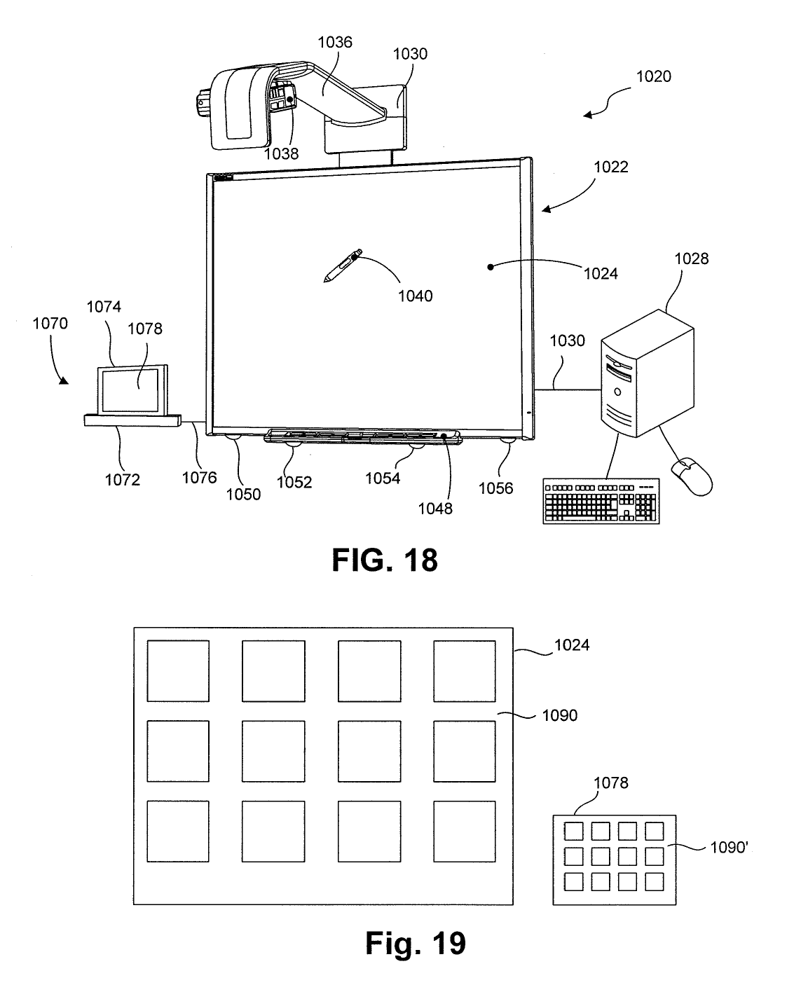

Turning now to FIG. 18, another embodiment of an interactive input system is shown and is generally identified by reference numeral 1020. In this embodiment, like reference numerals will be used to indicate like components of the first embodiment with a “1000” added for clarity. As can be seen, interactive input system 1020 is similar to that of interactive input system 20 with the addition of a docking station 1070 having a base 1072 for receiving a mobile computing device 1074 such as for example a tablet computer. In this embodiment, the tablet computer comprises a touch-sensitive screen 1078. The touch-sensitive screen 1078 is 7 to 10 inches in size, measured diagonally as is well known in the art. The docking station 1070 is coupled to the master controller of the interactive board 1022 via a USB cable 1076 or other suitable wired or wireless connection.

The base 1072 of the docking station 1070 comprises a receptacle (not shown) for receiving the mobile computing device 1074. The receptacle comprises an interface (not shown) such as for example a dock connector for connecting to an input/output (I/O) interface of the mobile computing device 1074. The dock connector is selected such that it is able to physically and electronically connect to the I/O interface of the mobile computing device 1074. When the mobile computing device 1074 is connected to the dock connector, the I/O interface receives input signals via the dock connector and outputs signals such as for example audio signals and video signals thereto.

A control circuit (not shown) associated with the docking station 1070 monitors the dock connector to detect the presence of the mobile computing device 1074. Upon detection of the mobile computing device 1074, a signal is sent from the control circuit to the master controller of the interactive board 1022 to switch the video input from the general purpose computing device 1028 to the docking station 1070, and thus the mobile computing device 1074. An application program running in the mobile computing device 1074 monitors the I/O interface of the mobile computing device 1074 and when the application program detects that the I/O interface is electrically connected to the dock connector associated with the docking station 1070, the output of the mobile computing device 1074 is set to the I/O interface as will be described. As such, the display image output by the mobile computing device 1074 via the I/O interface thereof in turn is displayed on the interactive surface 1024. In this embodiment, the touch-sensitive screen 1078 of the mobile computing device 1074 remains on such that the display image of the touch-sensitive screen 1078 is associated with the display image displayed on the interactive surface 1024. As will be appreciated, the touch-sensitive screen 1078 may turn off when the application program detects that the I/O interface is electrically connected to the dock connector associated with the docking station 1070.

FIG. 19 shows an exemplary display image 1090 output by the mobile computing device 1074 to the interactive surface 1024. The display image is also shown as presented on the touch-sensitive screen 1078 of the mobile computing device 1074, identified by reference numeral 1090′. As can be seen, the display image 1090 is generally an enlarged or scaled copy of the corresponding display image 1090′.

As will be appreciated, display image output by the mobile computing device 1074 to the interactive surface may require modification due to the size differential between the interactive surface 1024 and the touch-sensitive screen 1078. As such, prior to outputting the display image to the I/O interface, the mobile computing device 1074 performs a check to determine if the display image requires modification. If modification is not required, the display image is output to the I/O interface and in turn is displayed on the interactive surface 1024. If modification is required, the mobile computing device 1074 modifies the display image and outputs the modified image to the I/O interface. In turn, the modified image is displayed on the interactive surface 1024.

As mentioned previously, an application program running in the mobile computing device 1074 monitors the I/O interface of the mobile computing device 1074 and when the application program detects that the I/O interface is electrically connected to the dock connector associated with the docking station 1070, the output of the mobile computing device 1074 is set to the I/O interface.

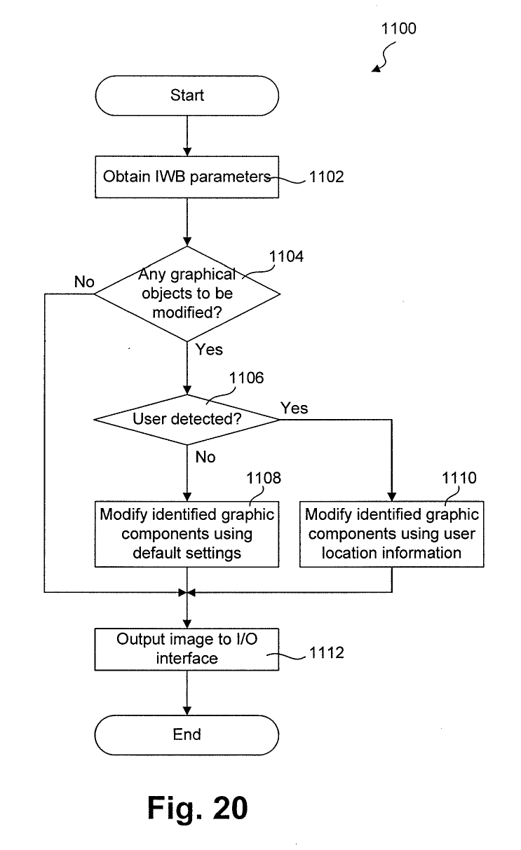

Turning now to FIG. 20, a flowchart showing a method for sending a display image to the I/O interface executed by the application program running on the mobile computing device 1074 is shown and is generally identified by reference numeral 1100. Method 1100 begins when the application program detects that the I/O interface is electrically connected to the dock connector associated with the docking station 1070. In other words, method 1100 begins when the mobile computing device 1074 is connected to the interactive board 1022 via the docking station 1070 and I/O interface. Upon connection, the application program receives parameters associated with the interactive board 1022 from the master controller of the interactive board 1022 (step 1102). In this embodiment, the parameters associated with the interactive board 1022 include the resolution and physical size of the interactive surface 1024 as well as user detection and location information as determined by the master controller of the interactive board 1022 and proximity sensors 1050 to 1056.

A check is then performed to determine if the display image comprises any graphical objects (e.g., buttons, icons, menus, windows, etc.) that need to be modified (step 1104). In this embodiment, some graphical objects are predetermined as being modifiable. Each modifiable graphical object comprises a predetermined maximum size and a predetermined preferred size. If the display image comprises one or more modifiable graphical objects, the received parameters associated with the interactive board 1022 are used to determine if the maximum size of each of the modifiable graphical objects will be exceeded when displayed on the interactive surface 1024 due to scaling. If the display image does not comprise any modifiable graphical objects or if no modifiable graphical object would exceed its maximum size when displayed on the interactive surface 1024, the method continues to step 1112. If one or more modifiable graphical objects would exceed its maximum size when displayed on the interactive surface 1024, a check is performed to determine if any user has been detected (step 1106). In this embodiment, the user detection information received from the master controller of the interactive board 1022 indicates the presence of one or more users. If no user has been detected, the application program modifies the one or more modifiable graphical objects that would exceed its maximum size when displayed on the interactive surface 1024 according to a set of predetermined parameters (step 1108) and resizes the modifiable graphical object according to the predetermined preferred size. In this embodiment, the set of predetermined parameters includes a predetermined location for displaying the modifiable graphical object. If one or more users have been detected, the application modifies the one or more modifiable graphical objects that would exceed its maximum size when displayed on the interactive surface 1024 using the user location information received from the master controller of the interactive board 1022 such that the location for displaying the modifiable graphical object corresponds to the location of a detected user, similar to that described above (step 1110) and resizes the modifiable graphical object according to the predetermined preferred size. The display image comprising the graphical objects is then output to the I/O interface of the mobile computing device 1074 and in turn, is displayed on the interactive surface 1024 of the interactive board 1020 (step 1112) and the method ends. It will be appreciated that graphical objects may also be modified in the above method according to size, shape, orientation, etc.

Once the display image of the mobile computing device 1074 is displayed on the interactive surface 1024, pointer activity proximate to the interactive surface 1024 is sent to the mobile computing device 1074 where the pointer activity can be recorded as writing or drawing or used to control the execution of one or more application programs executed by the mobile computing device 1074, similar to that described above. Similarly, user location information is periodically sent to the mobile computing device 1074 by the master controller of the interactive board 1022. As such, the display image on the interactive surface 1024 is modified in response to pointer activity and to user presence and location changes.

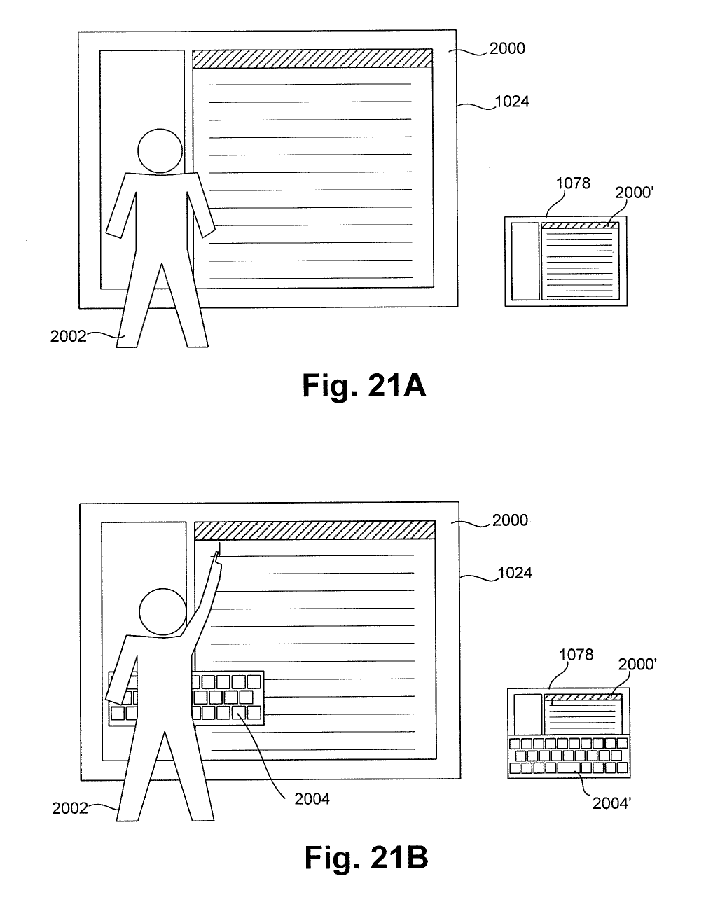

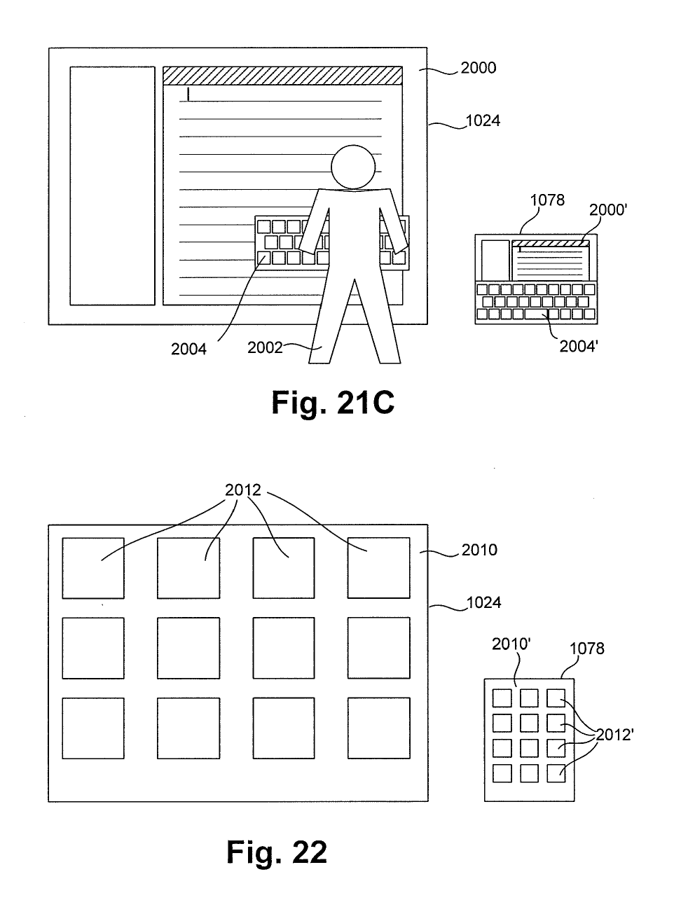

FIGS. 21A to 21C show an example of a display image in the form of a graphical user interface (GUI) 2000 sent from the mobile computing device 1074 to the interactive board 1022 and displayed on the interactive surface 1024. The corresponding GUI 2000′ displayed on the touch-sensitive screen 1078 is also shown.

A user 2002 initiates a command by pressing a button (not shown) to launch a word processing application program on the mobile computing device 1074 which displays a GUI 2000′ on the touch-sensitive screen 1078 as shown in FIG. 21A. The application program of the mobile computing device 1074 checks the GUI 2000′ and in this example determines that it does not comprise any modifiable graphical objects. As such, the GUI 2000′ is sent to the I/O interface and in turn, is displayed on the interactive surface 1024 as GUI 2000. As can be seen, GUI 2000 is a scaled image of GUI 2000′.

In FIG. 21B, user 2002 taps on the GUI 2000 at a location corresponding to a text input box, and thus initiates a command for entering text at the touch location. The pointer contact information is communicated to the mobile computing device 1074. As a result, a graphical object in the form of an on-screen keyboard 2004′ is added to the GUI 2000′ and displayed on the touch-sensitive screen 1078 of the mobile computing device 1074, as is well known. Due to the relatively small size of the touch-sensitive screen 1078, the on-screen keyboard 2004′ expands the entire width of and occupies approximately ⅓ the height of the touch-sensitive screen 1078, and thus occupies a significant portion of the touch-sensitive screen 1078. The application program of the mobile computing device 1074 checks the GUI 2000′ and in this example determines that it comprises a modifiable graphical object, namely the on-screen keyboard 2004′. As such, the application program modifies the GUI 2000′ by resizing the on-screen keyboard 2004′ according to the predetermined preferred size and by positioning the on-screen keyboard according to the user location information. The modified GUI 2000 is sent to the I/O interface and in turn, is displayed on the interactive surface 1024. As can be seen, GUI 2000 comprises on-screen keyboard 2004 positioned adjacent to the user 2002. The on-screen keyboard 2004 occupies a smaller portion of the GUI 2000 than the on-screen keyboard 2004′ occupies of GUI 2000′. The on-screen keyboard 2004 is appropriately sized to be used by the user 2002.

As shown in FIG. 21C, in the event the user 2002 moves about the space in front of interactive surface 1024, the location of the on-screen keyboard 2004 is updated to remain adjacent to the user 2002 based on the user location information received by the application program of the mobile computing device 1074. As can be seen, the on-screen keyboard 2004′ remains displayed on the touch-sensitive display 1078 of the mobile computing device 1074.

FIG. 22 shows an example of a display image in the form of a GUI 2010 sent from the mobile computing device 1074 to the interactive board 1022 and displayed on the interactive surface 1024. The corresponding GUI 2010′ displayed on the touch-sensitive display 1078 is also shown. GUI 2010 and GUI 2010′ comprise a set of icons 2012 and 2012′, respectively. In this example, the orientation of the touch-sensitive display 1078 is portrait, that is, the height of the display is larger than the width of the display. The orientation of the interactive surface 1024 is landscape, that is, the height of the surface is smaller than the width of the surface. The application program of the mobile computing device 1074 detects the orientation of the interactive surface 1024 based on the received parameters associated with the interactive board 1022. The application program of the mobile computing device 1074 checks the GUI 2010′ and in this example determines that it comprises a number of modifiable graphical objects, namely each of the icons 2012′. As such, the application program modifies the GUI 2010′ by rearranging the icons 2012′ to match the orientation of the interactive surface 1024. The modified GUI 2012 is sent to the I/O interface and in turn, is displayed on the interactive surface 1024. As can be seen, GUI 2012 comprises a set of icons 2012 oriented in a different manner than that of GUI 2012′. It will be appreciated that the orientation of the set of icons 2012 would match that of the set of icons 2012′, if the mobile computing device 1074 was in the same orientation as the interactive surface 1024.

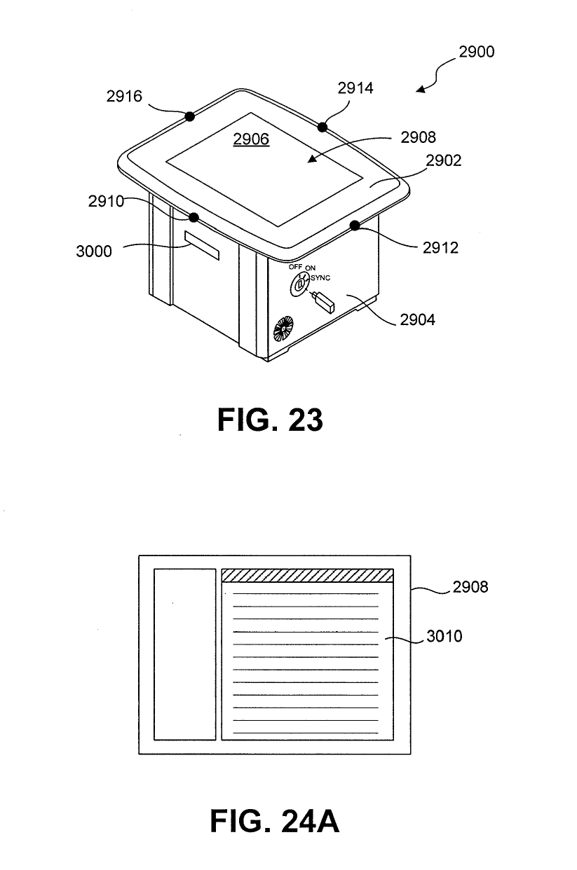

Turning now to FIG. 23, another embodiment of an interactive input system is shown and is generally identified by reference numeral 2900. In this embodiment, like reference numerals will be used to indicate like components of the first embodiment with a “2000” added for clarity. As can be seen, interactive input system 2900 is similar to that of interactive input system 900 with the addition of a docking station 3000 positioned below table top 2902 and having an opening within cabinet 2904 for receiving a mobile computing device such as for example a tablet computer. The docking station 3000 is coupled to the processing structure mounted within the cabinet 2904 via a USB cable (not shown).

The docking station 3000 is similar to docking station 1070 described above. The docking station 3000 comprises a receptacle for receiving the mobile computing device. The receptacle comprises an interface such as for example a dock connector for connected to an I/O interface of the mobile computing device.

A control circuit (not shown) associated with the docking station 3000 monitors the dock connector to detect the presence of a mobile computing device. Upon detection of a mobile computing device, a signal is sent from the control circuit to the processing structure mounted within the cabinet 2904 to switch the video input from the processing structure to the docking station 3000 and thus, the mobile computing device. An application program running on the mobile computing device monitors the I/O interface and when the application program detects that the I/O interface is electrically connected to the dock connector associated with the docking station 3000, the output of the mobile computing device is set to the I/O interface and the output display image is modified according to method 1100 described above. In this embodiment, modifications that can be made to a display image include modifying the size of a modifiable graphical object, modifying at least one graphical object, rearranging the orientation of one or more graphical objects, rotating one or more graphical objects, modifying the orientation of the display image, etc.

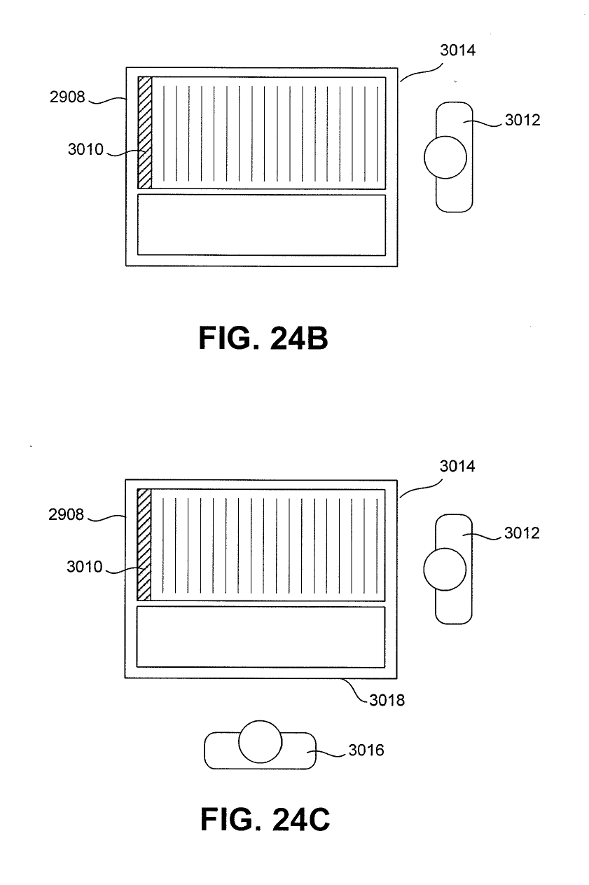

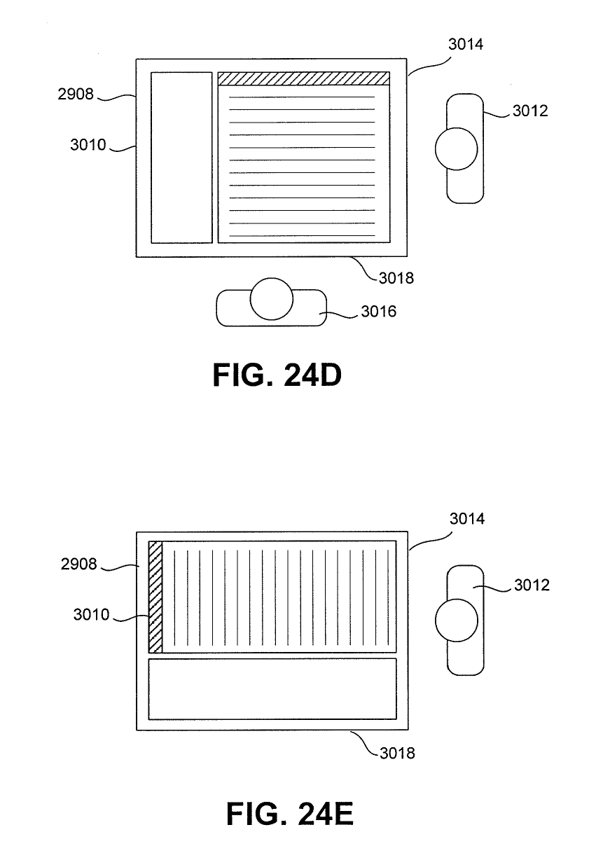

FIGS. 24A to 24E show an example of rotating a display image received from a mobile computing device and displayed on the display surface 2908 based on the output of proximity sensors 2910 to 2916.

As shown in FIG. 24A, an editing program is executed by the mobile computing device which in turn displays a display image in the form of a GUI 3010 on the display surface 2908. Although not shown, it will be appreciated that GUI 3010 is an enlarged copy of the display image presented on the touch-sensitive display associated with the mobile computing device. Since no user is detected by the proximity sensors 2910 to 2916, no user location information is received by the mobile computing device and thus the orientation of the GUI 3010 is set according to a default orientation. In the example shown, the GUI 3010 is displayed in a landscape orientation on display surface 2908. Although not shown in FIG. 24A, some graphical objects of GUI 2010 may be modified as described above to be sized according to the characteristics of the display surface 2908.

As shown in FIG. 24B, a user 3012 is detected at side 3014 of the display surface 2908. As such, user location information is communicated to the mobile computing device. In turn, the mobile computing device determines that the orientation of the GUI 3010 is to be updated. As a result, the application program in the mobile computing device reorients the GUI 3010 to a portrait orientation such that it appears upright when viewed by the user 3012. Although not shown, the display image presented on the touch-sensitive display of the mobile computing device is not updated.

As shown in FIG. 24C, a second user 3016 is detected at side 3018 of the display surface 2908. As such, user location information is communicated to the mobile computing device. The mobile computing device processes the user location information according to a predetermined rule, and as a result the GUI 3010 remains in a portrait orientation such that it appears upright when viewed by the user 3012, since user 3012 was the first detected user. As will be appreciated, the predetermined rule may be such that the GUI 3010 is rotated such that it appears upright when viewed by the newest detected user.

A user may initiate a command such as for example pressing a button (not shown) or performing a rotation gesture on the touch surface 2906 to rotate the displayed image. The command is communicated to the mobile computing device and as a result, the displayed image is rotated. An example is shown in FIG. 24D. As shown, once user 3012 or 3016 presses a button (not shown) to rotate the GUI 3010, the GUI 3010 is rotated in a clock-wise direction and as a result the GUI 3010 is rotated to a landscape orientation and appears upright when viewed by user 3016. As will be appreciated, the rotation may also be completed in a counter-clock-wise direction.

As shown in FIG. 24E, user 3016 has left the interactive input system 2900 environment and thus the proximity sensors only detect user 3012 at side 3014 of the display surface 2908. As such, user location information is communicated to the mobile computing device. In turn, the mobile computing device determines that the orientation of the GUI 3010 is to be updated. As a result, the application program in the mobile computing device reorients the GUI 3010 to a portrait orientation such that it appears upright when viewed by the user 3012.

Although in embodiments described above sensor information is processed by the master controller or processing structure associated with the interactive board or touch panel and user location information is communicated to the mobile computing device, wherein the mobile computing device processes the user location information to determine if the display image needs to be updated, those skilled in the art will appreciate that the master controller or processing structure may process the user location information to determine if the display image needs to be updated, and if so, send a command to the mobile computing device indicating that an update needs to be made. In this embodiment, the master controller or processing structure receives the output of the proximity sensors and determines the direction and orientation of the display image.

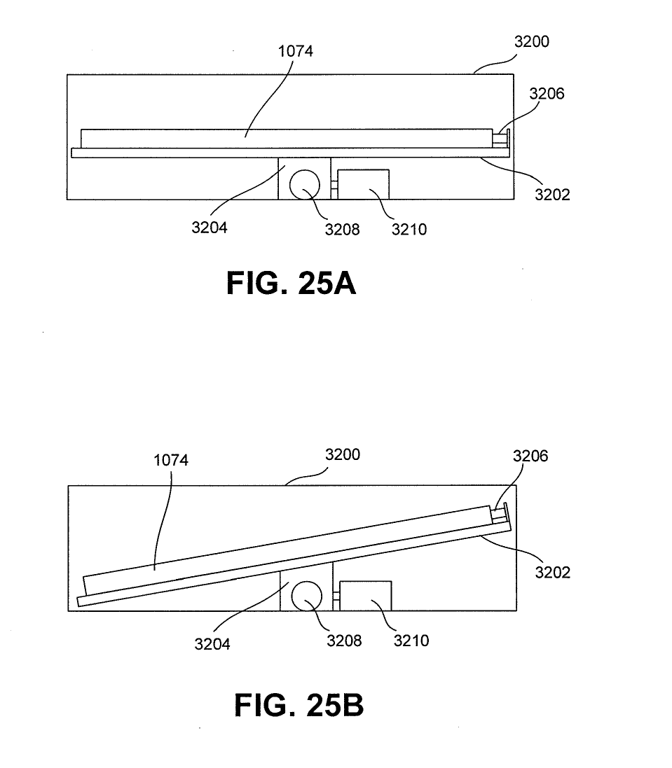

FIG. 25A shows a cross-sectional view of another embodiment of a docking station 3200 which may be used with interactive input system 2900 described above. In this embodiment, the docking station 3200 comprises a horizontally positioned platform 3202 for receiving a mobile computing device 1074. The platform 3202 is mounted on a supporting structure 3204 and may be tilted with respect thereto. An interface 3206 such as for example a dock connector is mounted at an end of the platform 3202 for connecting to the input/output (I/O) interface of the mobile computing device 1074. The interface 3206 is selected such that it is able to physically and electronically connect to the I/O interface of the mobile computing device 1074. A pair of servomechanisms 3208 and 3210 is coupled to the platform 3202 to tilt the platform under the control of an input signal (not shown) sent by the processing structure.

In this embodiment, the mobile computing device 1074 comprises one or more sensors such as for example an accelerometer. As is well known, the accelerometer is used to detect the orientation of the mobile computing device 1074, and based on the detected orientation, the display image displayed on the touch-sensitive display 1078 of the mobile computing device 1074 is updated. As shown in FIG. 25B, when the processing structure of the touch sensitive table determines that the display image needs to be rotated based on the output of the proximity sensors due to the presence or absence of a user, a signal is sent to the servomechanisms 3208 and 3210 to tilt the platform 3202. As a result, the mobile computing device 1074 is tilted to a corresponding direction with a predetermined angle which in this embodiment is between 10° and 15°. The accelerometer associated with the mobile computing device 1074 detects the tilting and automatically rotates the display image displayed on the touch-sensitive display 1078. As a result, the display image displayed on the display surface 2908 of the touch sensitive table.

Although embodiments are described above wherein the docking station is mounted to the cabinet under the table top, in other embodiments the docking station may be positioned at a location separate from the touch table and be coupled to the touch table via a wired or wireless connection.

Although embodiments are described above where user location information is communicated to the mobile computing device, those skilled in the art will appreciate that the mobile computing device may receive the output from the proximity sensors, and may determine user location information based on the output of the proximity sensors.

Although embodiments are described above wherein the docking station is coupled to the interactive board or touch panel, those skilled in the art will appreciate that the docking station may be connected to processing structure (e.g., the general purpose computing device or to the processing structure housed in the cabinet of the touch table) via any wired or wireless connection. In these embodiments, the processing structure receives display images from the mobile computing device and displays the received images on the display surface. The processing structure also receives output from proximity sensors and communicates the output from the proximity sensors to the mobile computing device via the docking station.

Although embodiments are described above wherein the docking station comprises a dock connector for engaging with an I/O interface of a mobile computing device, those skilled in the art will appreciate that alternatives are available. For example, the docking station may communicate with the mobile computing device via a wireless connection such as for example Bluetooth, Wi-Fi, etc. Further, in another embodiment a docking station is not required. In this embodiment, the interactive input system communicates with the mobile computing device via a wired or wireless connection. For example, the interactive input system may comprise an interface having a universal serial bus (USB) port and a video graphics array (VGA) port. In this example, a VGA cable is used to connect the video output of the mobile computing device to the VGA port of the interactive input system and a USB cable is used to connect the mobile computing device to the USB port of the interactive input system to communicate data such as for example pointer contact information.

Although embodiments are described above wherein a touch sensitive device is used (e.g., the interactive board 22 or the touch panel 906), those skilled in the art will appreciate that alternatives are available. For example, in another embodiment a display device such as for example an LCD panel or a projection system projecting images onto a planar surface may be used to display images and other types of input devices such as for example a mouse, a keyboard, a trackball, a slate, a touchpad, etc. may be used to enter input.

Although embodiments are described above wherein the interactive input system comprises a general purpose computing device and a docking station for receiving a mobile computing device, those skilled in the art will appreciate that in other embodiments the interactive input system only has a docking station for receiving a mobile computing device. In this embodiment, the interactive input system is used as an external display device of the mobile computing device.

Although embodiments are described above wherein the interactive input system comprises a docking station for receiving a mobile computing device as well as a proximity sensor, those skilled in the art will appreciate that alternatives are available. For example, in another embodiment the interactive input system need not have a proximity sensor. In this embodiment, once a mobile computing device is received by the docking station, the display image of the mobile computing device is modified based on the parameters of the interactive input system received by the mobile computing device. In turn, the display image presented on the interactive input surface is modified. No user position information is used to modify the displayed images.

Although embodiments have been described with reference to the drawings, those of skill in the art will appreciate that variations and modifications may be made without departing from the scope thereof as defined by the appended claims.

What is claimed is:

1. An interactive input system comprising:
an interactive surface; and
processing structure for receiving an image from a mobile computing device, and processing the received image for display on the interactive surface.

2. The interactive input system of claim 1 comprising at least one proximity sensor.

3. The interactive input system of claim 2 wherein the processing structure processes proximity sensor output to determine user location information.

4. The interactive input system of claim 3 wherein the user location information comprises an approximate location of at least one user positioned adjacent to the interactive surface.

5. The interactive input system of claim 4 wherein the processing structure processes the received image based at least on the approximate location of the at least one user.

6. The interactive input system of claim 5 wherein the processed received image is displayed on the interactive surface at a location corresponding to the approximate location of the at least one user.

7. The interactive input system of claim 5 wherein the processed received image is displayed on the interactive surface at an orientation corresponding to the approximate location of the at least one user.

8. The interactive input system of claim 5 wherein the processing structure processes the received image based on interactive surface information data.

9. The interactive input system of claim 8 wherein the interactive surface information data comprises at least one of a size of the interactive surface, and an orientation of the interactive surface.

10. The interactive input system of claim 9 wherein the received image comprises at least one graphical object.

11. The interactive input system of claim 10 wherein the at least one graphical object is modifiable.

12. The interactive input system of claim 11 wherein the processing structure associates at least one of a maximum size and a preferred size to each of the at least one modifiable graphical objects.

13. The interactive input system of claim 12 wherein the processing structure determines if at least one modifiable graphical object will exceed its associated maximum size after said processing.

14. The interactive input system of claim 13 wherein in the event that the at least one modifiable graphical object will exceed its associated maximum size after said processing, the at least one modifiable graphical object is displayed on the interactive surface at its preferred size.

15. The interactive input system of claim 14 wherein the at least one modifiable graphical object is displayed on the interactive surface at its preferred size at a location corresponding to the approximate location of the at least one user.

16. The interactive input system of claim 1 wherein the processing structure is connected to the mobile computing device through one of a wired and wireless connection.

17. The interactive input system of claim 1 further comprising a docking station for connecting the mobile computing device to the processing structure.

18. The interactive input system of claim 17 wherein the docking station comprises at least one servomechanism for tilting the docking station at a predefined angle.

19. The interactive input system of claim 18 wherein in response to tilting the docking station at the predefined angle, an orientation of the received image is adjusted.

20. A method comprising:
receiving an image from a mobile computing device; and
processing the received image for display on an interactive surface.

21. The method of claim 20 further comprising:
receiving sensor output from at least one sensor in proximity with the interactive surface and processing the sensor output to determine user location information.

22. The method of claim 21 further comprising:
determining an approximate location of at least one user positioned adjacent to the interactive surface based on the user location information.

23. The method of claim 22 further comprising:
displaying the processed received image at a location on the interactive surface corresponding to the approximate location of the at least one user.

24. The method of claim 22 further comprising:
displaying the processed received image at an orientation on the interactive surface corresponding to a viewpoint of the at least one user.

25. The method of claim 22 wherein the received image comprises at least one graphical object.

26. The method of claim 25 further comprising determining a size of the at least one graphical object when displayed on the interactive surface and if the size is greater than a maximum size, displaying the graphical object on the interactive surface at a preferred size.

27. The method of claim 26 wherein the graphical object is displayed on the interactive surface at a location corresponding to the approximate location of the at least one user.

27. The method of claim 21 further comprising:
determining a desired orientation of the received image based on the user location information; and
adjusting the orientation of the mobile computing device such that the received image is oriented at the desired orientation.

28. A non-transitory computer readable medium embodying a computer program for execution by a computer, the computer program comprising:
program code for receiving an image from a mobile computing device; and
program code for processing the received image for display on an interactive surface.
